(19) United States
(12) Patent Application Publication
(10) Pub. No.: US 2026/0288700 A1
(43) Pub. Date: Sep. 24, 2026

(54) SYSTEM

(71) Applicant: SoftBank Group Corp., Tokyo (JP)

(72) Inventor: Hiromi IINO, Tokyo (JP)

(73) Assignee: SoftBank Group Corp., Tokyo (JP)

(21) Appl. No.: 19/562,879

(22) Filed: Mar. 11, 2026

(30) Foreign Application Priority Data
Mar. 19, 2025 (JP) 2025-044968

(51) Int. Cl. G06F 16/23; G06F 16/242; G06F 16/28

(52) U.S. Cl. CPC G06F 16/2365; G06F 16/243; G06F 16/285

(57) ABSTRACT

A system includes a processor that is configured to: generate, in order to automatically determine a content discrepancy between an electronic contract, a document submitted on paper, and a document attached to a seal application, a prompt for instructing a generative AI model to analyze content of the documents, analyze, by using a text mining technique, the content of the documents in detail to extract specific keywords or phrases and to detect the content discrepancy, and analyze, in order to recognize an emotional state of a user, at least one of a voice tone of the user, a facial expression of the user, and a text input from the user, and adjust a method of notifying the content discrepancy based on the emotional state.

### CROSS-REFERENCE TO RELATED APPLICATION

This application is based on and claims priority under 35 USC 119 from Japanese Patent Application No. 2025-044968 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional document verification systems for seal applications and contract workflows primarily rely on manual review or simple rule-based comparisons to confirm consistency between an electronic contract and paper-based documents attached to a seal application. In such systems, a reviewer must visually compare clauses, amounts, dates, and other key items, which is time-consuming, prone to human error, and difficult to scale when the number of documents increases.

Although techniques such as OCR and basic keyword search have been introduced, these techniques are insufficient for accurately detecting subtle or context-dependent content discrepancies across different document formats and layouts.

Furthermore, existing systems treat notification to users as a uniform process, regardless of the emotional state or stress level of the user. As a result, users may receive discrepancy notifications in a manner or at a timing that increases frustration or reduces operational efficiency, particularly when many discrepancies are reported at once or when the discrepancies concern critical items such as contract amounts or dates.

Therefore, there is a need for a system that can (i) automatically and accurately determine content discrepancies between an electronic contract, a paper-submitted document, and a document attached to a seal application by using advanced generative AI models, text mining, and natural language processing, and (ii) recognize the emotional state of a user and adapt the method and priority of discrepancy notifications in accordance with that emotional state, thereby improving both the accuracy and the user experience of the seal application process.

### SUMMARY

To solve the above-described problems, according to one aspect of the present invention, there is provided a system comprising a processor, wherein the processor is configured to generate, in order to automatically determine a content discrepancy between an electronic contract, a document submitted on paper, and a document attached to a seal application, a prompt for instructing a generative AI model to analyze content of the documents; analyze, by using a text mining technique, the content of the documents in detail to extract specific keywords or phrases and to detect the content discrepancy; and analyze, in order to recognize an emotional state of a user, at least one of a voice tone of the user, a facial expression of the user, and a text input from the user, and adjust a method of notifying the content discrepancy based on the emotional state.

In one embodiment, the processor is configured to analyze the content of the documents by using a natural language processing technique and detect the content discrepancy, thereby enabling semantic-level comparison of clauses, amounts, dates, and other important items beyond simple keyword matching.

In another embodiment, the processor is configured to use an emotion engine that estimates the emotional state from at least one of the voice tone of the user, the facial expression of the user, and the text input from the user, and dynamically change at least one of a priority and a method of the notification based on an estimation result of the emotion engine. In this way, the system can, for example, postpone non-critical notifications, change the tone or detail level of the notification, or prioritize critical discrepancies when the user is inferred to be under stress, thereby improving usability and reducing cognitive load while maintaining high completeness and accuracy in discrepancy checking.

The term “processor” refers to one or more hardware processing units, such as a CPU, GPU, or dedicated computing circuit, and may include associated memory and control logic, that execute instructions to perform functions described in the present specification and claims.

The term “electronic contract” refers to a contract document represented in an electronic format, such as a PDF file, word processing file, or structured data file, that is stored, transmitted, or processed by a computer system without requiring a paper medium as its primary form.

The term “document submitted on paper” refers to a contract-related document that is originally created or provided in a physical, paper-based form, and that may be digitized by scanning or imaging for processing by the system.

The term “document attached to a seal application” refers to any document, including contracts, application forms, approval sheets, or related supporting materials, that is submitted in association with a request for a seal, signature, or formal authorization, and that is processed by the system as part of the seal application workflow.

The term “content discrepancy” refers to a difference or inconsistency in information, such as clauses, amounts, dates, party names, or other relevant content, between at least two documents, including an electronic contract, a document submitted on paper, and a document attached to a seal application.

The term “generative AI model” refers to an artificial intelligence model, such as a large language model or other generative model, that is capable of generating, transforming, or analyzing text or other content in response to input prompts, and that is used by the system to analyze the content of documents.

The term “prompt” refers to data, including textual instructions, questions, or formatting constraints, that is supplied to a generative AI model to instruct the generative AI model to perform a specific analysis, generation, or transformation of document content.

The term “text mining technique” refers to a computational method or combination of methods for processing natural language text, including but not limited to keyword extraction, phrase extraction, pattern detection, and statistical analysis, to identify, extract, or classify information relevant to detecting a content discrepancy.

The term “natural language processing technique” refers to an algorithmic method for analyzing and understanding human language text, including but not limited to tokenization, parsing, part-of-speech tagging, named entity recognition, semantic similarity computation, and contextual interpretation of clauses, to determine meaning or relationships within or between documents.

The term “user” refers to a human operator, such as an applicant, reviewer, or approver, who interacts with the system to submit documents, receive notifications, or review analysis results in the context of a seal application or similar workflow.

The term “voice tone of the user” refers to acoustic characteristics of the user's speech, including but not limited to pitch, volume, speed, intonation, and prosody, which are analyzed by the system to estimate an emotional state of the user.

The term “facial expression of the user” refers to visual features of the user's face, including but not limited to movements or configurations of eyes, eyebrows, mouth, and other facial muscles, which are captured by an image input device and analyzed by the system to estimate an emotional state of the user.

The term “text input from the user” refers to character-based data, such as words, sentences, or chat messages, that are entered by the user through a keyboard, touch interface, or other input device, and that are analyzed by the system to estimate an emotional state of the user or to understand user intent.

The term “emotional state” refers to a mental or affective condition of the user, such as stress, calmness, frustration, satisfaction, or urgency, which is inferred by the system based on analysis of at least one of the user's voice tone, facial expression, and text input.

The term “method of notifying the content discrepancy” refers to a manner in which the system communicates the presence or details of a content discrepancy to the user, including but not limited to a notification channel, a timing of notification, a format or layout of notification content, and a tone or level of detail of the notification.

The term “emotion engine” refers to a software and/or hardware component that processes at least one of voice tone, facial expression, and text input of the user to estimate an emotional state, and outputs corresponding emotional state data or parameters for use by other components of the system.

The term “priority of the notification” refers to a relative importance level assigned by the system to a specific notification about a content discrepancy, which may influence the order, timing, or prominence with which the notification is presented to the user.

The term “dynamic change” refers to a modification performed automatically by the system at run time, in response to changing conditions such as an estimated emotional state of the user, without requiring manual reconfiguration, and may involve updating parameters, rules, or behaviors related to notifications.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

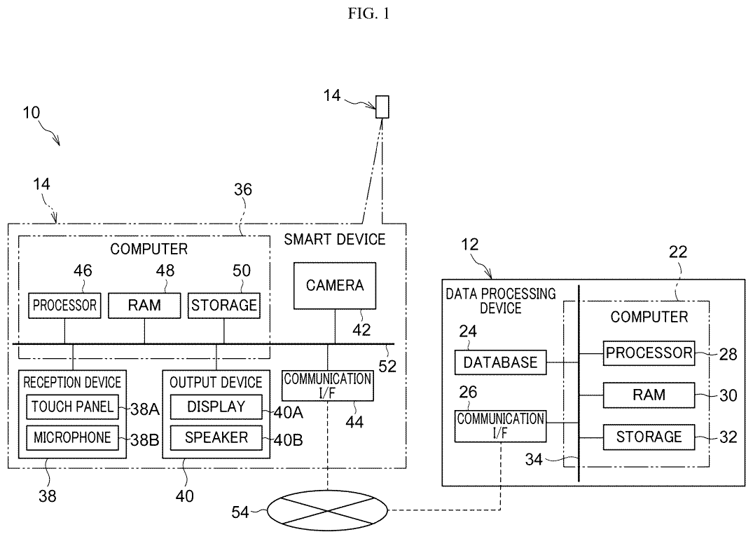

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

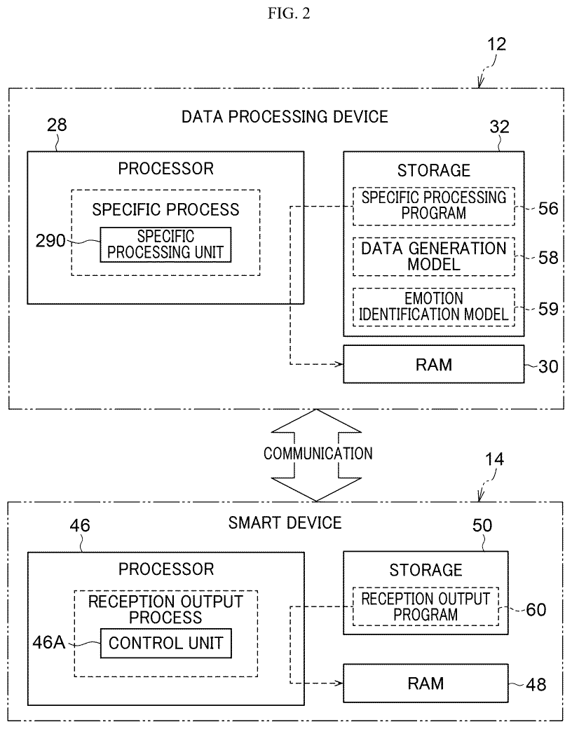

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In many organizations, electronic documents, documents recorded on physical media, and documents attached to approval procedures must be compared to ensure that their contents are consistent. Conventional systems typically rely on rule-based comparison of plain text or manual checking by human reviewers. These approaches suffer from several technical shortcomings.

First, conventional systems often operate on unstructured text without robust extraction of semantic units such as clauses, numerical values, dates, and parties. As a result, the systems either fail to detect inconsistencies at a fine-grained field level or generate excessive false positives that degrade system reliability. This leads to inefficient use of computing resources, because repeated full-text comparisons are performed without leveraging structured representations that would allow more targeted processing.

Second, existing systems generally do not employ a coordinated pipeline that converts heterogeneous document formats (e.g., scanned images and born-digital documents) into normalized structured information suitable for machine learning-based inconsistency detection. Optical character recognition, natural language processing, and machine learning, if used at all, are often implemented as loosely coupled modules. This loose coupling leads to redundant data transformations, inconsistent intermediate representations, and increased latency in end-to-end processing. The lack of an integrated comparison-result representation also makes it difficult for subsequent components to reuse intermediate results efficiently.

Third, even when machine learning models are applied, conventional systems usually provide only low-level flags or scores indicating potential inconsistencies, without generating explanations that are aligned with the underlying structured data and comparison results. Human reviewers must manually interpret scattered indicators and cross-check original documents, which increases cognitive load and processing time. In particular, generic natural-language generation that is not tightly driven by the structured comparison data tends to produce explanations that are incomplete, inconsistent with the actual comparison, or difficult to trace back to specific fields.

Fourth, most conventional systems do not incorporate user feedback about the correctness of inconsistency determinations and generated explanations in a systematic, machine-readable form that can be reused to evaluate and improve the underlying determination models. As a result, model performance cannot be effectively monitored or adapted to domain-specific characteristics, limiting the system's ability to improve over time.

Fifth, existing notification and user-interface mechanisms are typically static, and do not adapt the configuration, emphasis, or ordering of displayed information based on a computed case-level severity or importance derived from structured inconsistency results and model confidence. This reduces the efficiency with which reviewers can prioritize and resolve the most critical inconsistencies and can cause unnecessary consumption of user attention and computing resources for low-risk cases.

Accordingly, there is a need for a technical solution that provides an integrated, processor-implemented pipeline that: (i) converts heterogeneous document sources into structured information; (ii) aligns corresponding information units across multiple related documents; (iii) applies a trained determination model to detect content inconsistencies with confidence measures; (iv) tightly couples a generative AI model with the structured comparison results via explicit prompt sentences; and (v) records user feedback to enable systematic evaluation and updating of the determination model.

Such a system would improve the functioning of the computer itself by optimizing the way document comparison data are represented, processed, and presented, thereby reducing processing redundancy, improving accuracy and explainability of the determinations, and enabling adaptive tuning of the underlying models.

The specific processing by the specific processing unit 290 of the data processing device 12 in Example 1 is realized by the following means.

The present invention provides a server comprising a processor configured to acquire, from an input device or a communication network, an information group including electronic information, information recorded on a physical medium, and information attached to an approval procedure, to execute an optical character recognition process on at least a portion of the information group to generate first information including character information, to analyze the first information by executing natural language processing and information extraction to generate structured information including clause information, numerical information, date information, and subject information, to align, on the basis of the structured information, a plurality of information units corresponding to one another among the electronic information, the information recorded on the physical medium, and the information attached to the approval procedure and to generate, for each of the information units, at least one comparison-target information pair, to input each comparison-target information pair to a determination model learned on the basis of machine learning and to generate, for each comparison-target information pair, determination information indicating presence or absence of a content inconsistency and a reliability of the determination, to classify, on the basis of the determination information, information units for which a content inconsistency is detected, information units for which a content inconsistency is not detected, and information units for which a determination is not possible and to generate, in accordance with a classification result, importance information and notification-priority information for each case, to construct a prompt sentence as an input text for generation of explanation information in natural language from comparison-result information including the structured information and the determination information, to input the prompt sentence and the comparison-result information to a generative artificial-intelligence model and to cause the generative artificial-intelligence model to generate explanation information including a summary of the content inconsistency and an explanation of an impact thereof, to generate, on the basis of the explanation information and the importance information, display information or transmission information for a user and to output the display information or the transmission information so as to visually emphasize a location and a content of the content inconsistency, and to acquire, from the user, evaluation information regarding the explanation information and validity information regarding the determination information and to store the evaluation information and the validity information as history information usable for performance evaluation and updating of the determination model. This enables an integrated computer-implemented processing pipeline that converts heterogeneous document sources into a unified structured representation, performs machine learning-based inconsistency detection with associated confidence values, drives a generative artificial-intelligence model using explicit prompt sentences constructed from the structured comparison results, and adapts both the notification behavior and the underlying determination model based on recorded user feedback, thereby improving accuracy, efficiency, and explainability of content inconsistency detection in a manner that enhances the overall functioning of the server system.

The term “electronic information” refers to information that is stored or transmitted in a digital format by an electronic device, including but not limited to electronic documents, electronic contracts, and digital images of documents.

The term “information recorded on a physical medium” refers to information that is fixed on a tangible substrate, such as paper or another recording material, and that is obtained by scanning or imaging the substrate to produce digital data.

The term “information attached to an approval procedure” refers to information contained in one or more documents that are submitted as part of a workflow for obtaining authorization, consent, or agreement, including attachments to approval requests, application forms, and related supporting materials.

The term “information group” refers to a set of information items that includes at least one instance of electronic information, information recorded on a physical medium, and information attached to an approval procedure, and that is processed collectively by the server.

The term “optical character recognition process” refers to a computerized process that analyzes image data containing characters and converts the image data into machine-readable character codes, thereby generating text data from the image data.

The term “first information” refers to text data including character information that is generated by applying the optical character recognition process and that represents the contents of the information group in a machine-readable textual form.

The term “natural language processing” refers to computerized processing of text written in a human language, including at least one of tokenization, sentence segmentation, part-of-speech tagging, parsing, named-entity recognition, and semantic analysis.

The term “information extraction” refers to a computerized process that analyzes text data to identify and extract specific items of interest, such as entities, attributes, or relationships, and to convert the identified items into a structured representation.

The term “structured information” refers to information organized according to a predefined data model, such as a set of fields or attributes, and including at least clause information, numerical information, date information, and subject information, so that each item can be individually accessed and processed.

The term “clause information” refers to structured information representing a logical provision or segment of a document, such as a contractual clause, condition, or term, that can be distinguished from other provisions within the same document.

The term “numerical information” refers to structured information representing quantities expressed as numbers, including amounts of money, counts, percentages, and other numeric values contained in a document.

The term “date information” refers to structured information representing temporal values, including calendar dates, times, periods, effective dates, expiration dates, and other time-related expressions contained in a document.

The term “subject information” refers to structured information representing an entity that participates in or is referenced by the content of a document, including but not limited to persons, organizations, and other parties.

The term “information unit” refers to a minimal processing element of structured information, such as a single field, attribute, or clause representation, that can be individually compared across multiple documents.

The term “comparison-target information pair” refers to a pair of information units that correspond to each other across two or more documents and that are selected for comparison to determine whether a content inconsistency exists.

The term “determination model” refers to a computational model generated through machine learning using training data, the model being configured to receive, as input, a comparison-target information pair or a feature vector derived therefrom and to output determination information indicating a classification or assessment related to a content inconsistency.

The term “machine learning” refers to a class of computational techniques in which a model is trained using data so that the model can infer patterns and make predictions or classifications, without being explicitly programmed with rules for all possible input conditions.

The term “determination information” refers to information output by the determination model that indicates, for a comparison-target information pair, at least whether a content inconsistency is present or absent and optionally a reliability value associated with the determination.

The term “content inconsistency” refers to a state in which information units that are expected to have consistent contents across documents differ from each other, including but not limited to differences in numerical values, dates, subjects, or clauses.

The term “reliability” refers to a value, such as a probability or confidence score, that indicates the degree of certainty or trust associated with the determination information produced by the determination model.

The term “classification result” refers to a result obtained by categorizing information units into at least a set of information units for which a content inconsistency is detected, a set of information units for which a content inconsistency is not detected, and a set of information units for which a determination is not possible.

The term “importance information” refers to information representing a degree of significance or severity of detected content inconsistencies for a particular case, calculated on the basis of at least the type, number, and reliability of inconsistencies.

The term “notification-priority information” refers to information representing a priority level for notifying a user about results of inconsistency detection for a particular case, the priority being determined based on the importance information or related metrics.

The term “comparison-result information” refers to information that aggregates at least the structured information, the alignment of information units, the comparison-target information pairs, and the determination information, and that represents the outcome of comparing multiple documents.

The term “prompt sentence” refers to text data that is constructed as an instruction or query for a generative artificial-intelligence model, the text data specifying at least a role, task, or perspective for the model and optionally embedding or referencing comparison-result information.

The term “generative artificial-intelligence model” refers to a computational model that is configured to generate text or other data in response to input, using learned parameters obtained from training on example data, and that can produce natural-language explanation information when provided with a prompt sentence and associated context.

The term “explanation information” refers to natural-language information generated by the generative artificial-intelligence model that describes at least a summary of detected content inconsistencies and an explanation of their potential impact or relevance.

The term “display information” refers to information formatted for presentation on a user interface, including arrangements, highlights, and visual elements that indicate locations and contents of detected content inconsistencies.

The term “transmission information” refers to information that is prepared for delivery to a user or another system via a communication channel, such as an email message, notification message, or machine-to-machine communication payload, and that includes at least part of the explanation information or comparison-result information.

The term “history information” refers to stored information that records past processing events, including evaluation information and validity information supplied by users, and that is used for performance evaluation, tuning, or updating of the determination model.

The term “evaluation information” refers to information received from a user that assesses the quality, usefulness, or correctness of the explanation information generated by the generative artificial-intelligence model.

The term “validity information” refers to information received from a user that indicates whether a particular determination information output by the determination model is correct, incorrect, or requires further review.

The term “case” refers to a logical grouping of documents, comparison operations, and associated results that pertain to a single transaction, approval procedure, contract, or similar unit of work processed by the system.

The term “evaluation index” refers to a quantitative or qualitative metric computed for each case, based on at least the type, number, and reliability of content inconsistencies, and used to control or adapt presentation and notification behavior of the system.

In one embodiment, a server includes at least one processor, a memory, a non-transitory storage device, and a network interface. The server executes an operating system such as a server-class operating system and application software implementing an optical character recognition engine, a natural language processing library, a machine learning framework, and a generative AI client. The server is connected via a network to one or more terminals. Each terminal includes a processor, a display, an input device, and a communication module, and executes a web browser or dedicated client application. A user operates the terminal to upload documents, review analysis results, and provide feedback.

The server stores uploaded documents in a persistent storage device, for example a magnetic disk drive or a solid-state drive, logically organized in a document repository. The stored documents include electronic information, such as digital contracts generated by a document authoring application, information recorded on a physical medium, such as scanned images of paper-based contracts in a portable document format, and information attached to an approval procedure, such as attachments to an approval request. The server stores, for each document, metadata including a document identifier, a case identifier, a document type, and access control attributes in a structured database.

The server executes an optical character recognition engine, such as an open-source OCR engine, on pages that contain image data. The server converts each page into a grayscale or binarized representation and applies page segmentation to identify text regions, line regions, and character candidates. The OCR engine performs character classification using a trained character recognition model stored in the server's memory and outputs encoded character sequences for each detected line.

The server merges the recognized lines into a text stream corresponding to each page and concatenates page-level text into a complete text representation for each document. The server stores the resulting text as first information in an associated text field in the database, together with an OCR quality score computed from recognition confidence values.

The server applies natural language processing to the first information using a language processing library such as a tokenization and parsing toolkit. The server tokenizes the text into sentences and tokens, associates part-of-speech tags with the tokens, and identifies named entities corresponding to dates, amounts, and organizations. The server executes pattern-based rules and finite-state transducers that recognize clause boundaries, such as sections and numbered provisions, by detecting header patterns, numbering schemes, and keywords indicative of contractual clauses. The server then groups tokens and sentences into clause information objects and extracts numerical information and date information by applying regular expressions and parsing logic that normalize numerical formats and date formats into canonical representations.

The server represents the extracted data as structured information using a predefined schema. In one example, the server constructs a data record containing fields such as clause_id, clause_type, clause_text, amount_value, amount_currency, date_value, date_type, and subject_identifier. The server stores these records in a relational database table or a key-value store linked to each document identifier. This structured representation allows the server to address and retrieve individual information units, rather than processing entire documents as monolithic text strings, thereby reducing the volume of data that must be processed during comparison operations.

The server aligns information units across multiple documents associated with the same case. The server selects, for example, a main electronic contract as a reference document and one or more related documents, such as a scanned signed contract and approval attachments, as comparison targets. The server computes alignment candidates based on matching of clause types, semantic similarity of clause_text fields, and equality or approximate equality of date_value and subject_identifier fields. The server may compute a similarity score using a vector representation of text, such as word or sentence embeddings generated by a neural network-based encoder, and then perform a matching algorithm, such as a bipartite graph matching or dynamic programming alignment, to identify corresponding information units. The server stores the results of this alignment in a comparison table that links each information unit in the reference document to one or more information units in the related documents.

The server converts each pair of aligned information units into a feature vector suitable for input to a determination model. The feature vector can include, for example, numerical differences between corresponding numerical information, normalized temporal differences between corresponding date information, categorical encodings of clause types, and similarity scores between clause text segments computed by a text similarity function. In one embodiment, the server normalizes numerical differences by a reference amount to obtain scale-invariant features, and encodes categorical attributes using one-hot or embedding representations. The server stores the feature vectors temporarily in memory or in a feature store for batch processing.

The server implements the determination model as a trained neural network running on a machine learning framework. For example, the determination model may comprise an input layer that receives the feature vector, one or more hidden layers implemented as fully connected layers with rectified linear unit activation functions, and an output layer that produces a probability distribution over classes such as “match,” “mismatch,” and “undetermined.” Alternatively, the determination model may include a recurrent or transformer-based layer when sequence-level context within clause_text is used as part of the feature set. The server stores the model parameters, including weights and biases, in a model file on the storage device and loads them into memory for inference.

The server trains the determination model offline or in a separate training module using historical labeled data containing known pairs of information units and ground-truth labels for content inconsistency. The server computes a loss function, for example a cross-entropy loss between the predicted class probabilities and the true labels, and updates the model parameters by applying a gradient-based optimization algorithm such as stochastic gradient descent or an adaptive gradient method. During training, the server may perform data augmentation by introducing controlled noise to numerical values, date offsets, or paraphrased clause_texts in order to improve model robustness.

The training process yields a set of weights that encode patterns of inconsistencies that are not easily captured by simple rule-based systems.

During inference, the server passes the feature vectors for each comparison-target information pair through the determination model and obtains determination information that includes both a predicted class label and a reliability value, such as a maximum class probability. The server interprets a low reliability value as an indication that the model cannot confidently determine whether a content inconsistency exists. The server classifies each information unit into one of several categories, including an inconsistency-detected category, a consistent category, and an undetermined category. These categories are derived by applying thresholds on the reliability value and class probabilities, which are stored as configuration parameters and may be tuned for performance.

The server computes importance information and notification-priority information at a case level by aggregating the determination information across all comparison-target information pairs associated with the case. For example, the server assigns higher importance scores to inconsistencies in total contract amount or contract term clauses than to inconsistencies in auxiliary descriptions. The server calculates an evaluation index that combines the count of high-severity inconsistencies, the average reliability, and the presence of undetermined units requiring further review. This evaluation index is used to determine how prominently the server should present the case to the user and in what order the server should list multiple cases on a dashboard. By computing and using such indices, the server optimizes the ordering and visualization of cases so that limited display resources and user attention are directed to the most critical items, reducing overall review time.

The server constructs a prompt sentence to be used as input to a generative AI model. The prompt sentence integrates structured comparison-result information, including descriptions of mismatched amounts, dates, and clauses, together with an instruction indicating a desired analysis mode. For example, the server may generate a prompt sentence such as: “You are a contract review assistant.

Based on the following comparison between Document A and Document B, summarize all mismatches in clauses, amounts, and dates, and explain their potential impact on payment obligations and contract validity in plain English.” The server appends a human-readable listing of key comparison results to the prompt sentence, ensuring that the generative AI model receives context that is directly derived from the structured data.

The server communicates with a generative AI model hosted locally or accessible through a network-based inference endpoint. The generative AI model can be implemented, for example, as a transformer-based neural network with an encoder-decoder architecture trained on large corpora of text data. The server sends the prompt sentence to the generative AI model via an application programming interface, receives generated explanation information from the model, and stores the explanation information in association with the corresponding case. Because the server constructs the prompt sentence from precise, structured comparison results, the generated output is tightly aligned with the actual detected inconsistencies, thereby improving the reliability and traceability of the explanations and reducing the need for repeated manual cross-checking.

The user can modify or refine the analysis by providing a custom prompt sentence via an input field displayed on the terminal. For example, the user may input: “Explain only the differences in payment terms and assess whether they could change the total amount payable.” The terminal transmits this user-defined prompt to the server. The server combines the user-defined prompt with the comparison-result information and generates a new augmented prompt sentence that explicitly instructs the generative AI model to focus on specific aspects of the inconsistencies. The server then obtains updated explanation information from the generative AI model and presents it to the user.

This configuration allows the server to serve as an adaptive interface between the user and the generative AI model, ensuring that the model is consistently supplied with structured, case-specific context while honoring user preferences regarding the analysis focus.

The server generates display information for presentation on the terminal. The display information may include a list of cases ordered by importance information, visual markers indicating the presence and severity of inconsistencies, and side-by-side views of corresponding clauses and fields across documents. The server emphasizes locations of inconsistencies by using color highlighting, icons, or layout changes encoded in a markup language, which the terminal renders using the browser engine. The server also generates transmission information, such as email notifications, that include summaries of critical inconsistencies and links to the analysis dashboard. These visualization and notification mechanisms are not mere business alerts; they are constructed based on structured evaluation indices and model outputs, which are computed using algorithmic transformations that leverage the internal data representations, thereby reducing unnecessary network traffic and avoiding transmission of unimportant cases.

The user reviews the displayed information on the terminal and may provide feedback on the validity of determination information and the usefulness of explanation information. For example, the user may designate a detected mismatch as a false positive or confirm a critical mismatch as correct. The terminal transmits these evaluations to the server. The server stores such evaluation information and validity information in a history repository linked to the corresponding comparison-target information pairs and model outputs. The server can later use this history information as additional labeled data for retraining or fine-tuning the determination model, or for calibrating reliability thresholds. This closed feedback loop enables the server to continuously adjust its internal models to the characteristics of the document domain in which it is deployed, which is a technical improvement over static rule-based or non-adaptive systems.

Because the server operates on structured information units and uses learned models to recognize complex patterns across multiple heterogeneous documents, the system performs operations that cannot feasibly be reproduced by simple manual inspection or straightforward automation of human procedures. The server reduces redundant processing by reusing structured intermediate representations across multiple analyses and by limiting re-processing to updated or newly uploaded documents. The use of feature vectors and neural network-based inference provides improved accuracy and robustness in inconsistency detection compared with traditional rule-only approaches, particularly in cases where inconsistencies are subtle, involve paraphrased language, or arise from correlated changes across multiple fields. As a result, the server achieves reduced computation time per case and lower error rates in determinations, which constitutes an improvement to computer technology in the field of document analysis and comparison.

In alternative embodiments, the server may employ different types of determination models, such as gradient-boosted decision trees or hybrid models combining neural networks and rule-based post-processing. The server may also implement different network architectures for the generative AI model, such as encoder-only or decoder-only transformers, and may compress or quantize models to reduce memory consumption and inference latency. The server may distribute processing across multiple processors or nodes, such as assigning OCR tasks to one processor group and machine learning inference to another group, thereby improving throughput and scalability.

In another embodiment, the server can operate in an environment with limited network bandwidth by caching comparison-result information and explanation information locally at the terminal, reducing repeated transmissions. The server can also adapt the level of detail in transmitted explanations based on the importance information, sending only high-level summaries for low-importance cases and detailed field-level analyses for high-importance cases. These configurations contribute to reduced communication load and more efficient use of computational and network resources.

Across these embodiments, the server, the terminal, and the user cooperate in a manner where the core technical contributions reside inside the server's processing pipeline. The server implements specific data structures for structured information and comparison-result information, executes defined algorithms for feature extraction, model inference, and case-level evaluation, and generates targeted prompt sentences for a generative AI model. These technical features collectively enhance processing speed, improve determination accuracy, reduce storage redundancy, optimize network traffic, and improve the usability and interpretability of results, thereby providing a concrete improvement to computer-based document inconsistency detection beyond mere automation of human review.

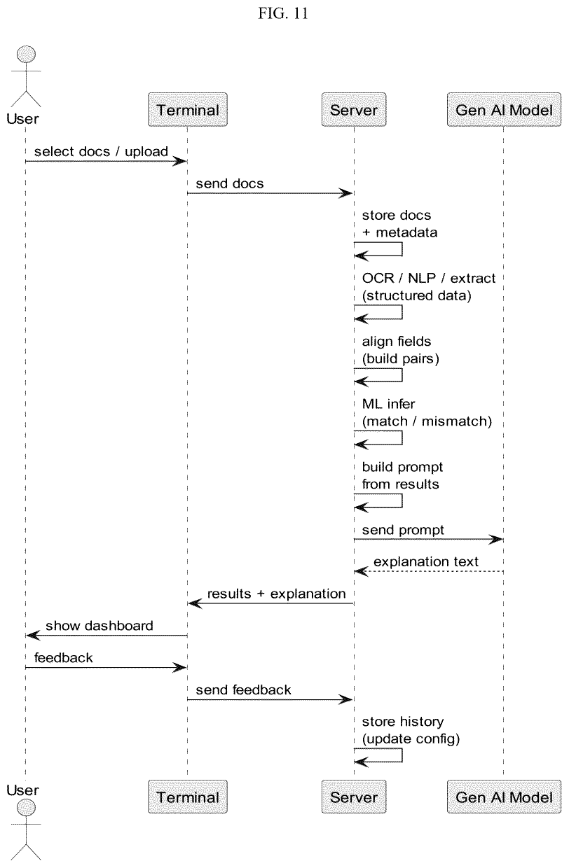

The following describes the processing flow using FIG. 11.

### Step 1

The user selects one or more documents on the terminal and initiates an upload operation.

The terminal displays a file selection dialog, allows the user to choose electronic documents or scanned images, and sends the selected files to the server over a secure communication channel.

Input: local document files (for example, PDF files, image files) selected by the user on the terminal.

Output: an HTTP request containing the document files transmitted from the terminal to the server.

The terminal packages the files into a multipart request and attaches metadata such as a case identifier or document type before transmission.

### Step 2

The server receives the uploaded files and stores them in persistent storage.

The server validates file formats and sizes, assigns a unique document identifier to each file, and registers document metadata in a database.

Input: HTTP request containing document files and optional metadata from the terminal.

Output: stored raw document data (for example, binary file objects) and corresponding document records in a database.

The server writes the files to a designated directory or storage volume and inserts database records including document_id, case_id, file_path, file_type, and upload_timestamp.

### Step 3

The server determines whether each stored document requires optical character recognition processing.

The server inspects each file to detect whether textual content is already embedded or whether the content consists of image data only.

Input: stored document files and associated metadata indicating file type and structure.

Output: a classification result for each document indicating “text-embedded” or “image-based,” and a processing queue of documents requiring OCR.

The server uses a document parsing library to scan for text objects and flags documents that lack such objects for OCR processing.

### Step 4

The server executes an optical character recognition engine on image-based pages to generate textual representations.

The server converts each page into a normalized image (for example, grayscale and binarized), segments the page into text regions, and applies character recognition to each region.

Input: image-based document pages retrieved from the stored document files.

Output: page-level text strings and recognition confidence scores for each recognized segment.

The server calls the OCR engine with language and layout parameters, collects recognized lines of text, and records confidence values per token or per line.

### Step 5

The server aggregates page-level OCR results into complete text data for each document.

The server concatenates page texts in page order, inserts page delimiters if needed, and stores the aggregated text in the database as first information.

Input: page-level text strings and associated page identifiers obtained from the OCR engine.

Output: document-level text data (first information) linked to the corresponding document_id.

The server updates the document record to include a text field and an OCR_status flag set to “completed,” and logs any OCR errors in a diagnostic table.

### Step 6

The server applies natural language processing to the first information to obtain token-level and sentence-level structure.

The server splits the text into sentences, tokenizes sentences into words or subwords, and assigns part-of-speech tags and other linguistic annotations.

Input: document-level text data (first information) for each document.

Output: annotated text structures including sentence boundaries, token lists, and linguistic tags.

The server invokes a natural language processing library with language-specific models and stores the resulting annotations in intermediary data structures in memory or as serialized objects.

### Step 7

The server performs information extraction to obtain clause information, numerical information, date information, and subject information.

The server detects clause boundaries using patterns such as numbered headings and key phrases, and extracts numerical values, dates, and participating entities from the annotated text.

Input: annotated text structures produced by the natural language processing step.

Output: structured information records containing fields for clause identifiers, clause text, numerical values, date values, and subject identifiers.

The server applies rule-based extractors and regular expressions to identify text spans of interest, normalizes numbers and dates into standard formats, and maps entity mentions to subject identifiers.

### Step 8

The server stores the structured information in a database for later comparison and analysis.

The server creates or updates database tables that hold clause records, value records, and entity records associated with each document.

Input: structured information records generated by the information extraction step.

Output: persistent structured data linked to document identifiers and case identifiers.

The server inserts rows into relational tables or saves serialized structured objects in a data store, ensuring that each information unit can be retrieved by key.

### Step 9

The server groups documents belonging to the same case and identifies reference and comparison documents.

The server uses case identifiers and document types to decide which document serves as the main reference and which documents are treated as related documents for comparison.

Input: document metadata including case_id and document_type from the database.

Output: document groupings that define sets of documents per case, including reference and comparison roles.

The server constructs grouping structures in memory that list document_ids for each case and mark their roles.

### Step 10

The server aligns information units across documents in each group to form comparison-target information pairs.

The server matches clauses and fields between the reference document and each related document based on clause type, text similarity, and matching of key attributes such as date or amount.

Input: structured information for all documents in a case group and grouping information from the previous step.

Output: aligned pairs (or sets) of information units, each represented as a comparison-target information pair.

The server computes similarity scores between clause_text fields, applies thresholding to filter unlikely matches, and records the indices of matched units in a comparison table.

### Step 11

The server generates feature vectors representing characteristics of each comparison-target information pair.

The server calculates numerical differences, temporal offsets, categorical encodings of clause types, and similarity metrics between text segments, and aggregates them into vector form.

Input: comparison-target information pairs including clause texts, numerical values, dates, and subject identifiers.

Output: feature vectors suitable for input to the determination model, each associated with an identifier for the underlying comparison-target information pair.

The server normalizes numeric values (for example, scaling by reference amounts), represents categorical values using embeddings or one-hot encodings, and concatenates all features into ordered vectors.

### Step 12

The server applies a trained determination model to the feature vectors to assess content inconsistencies.

The server feeds each feature vector into a neural-network-based classifier, computes forward passes through input, hidden, and output layers, and obtains predicted class probabilities.

Input: feature vectors representing comparison-target information pairs.

Output: determination information consisting of predicted labels (for example, “match,” “mismatch,” “undetermined”) and associated reliability values for each pair.

The server uses stored model parameters loaded into memory, performs matrix multiplications and non-linear activations, and produces probability distributions over classes via a softmax or similar function.

### Step 13

The server classifies information units into categories based on the determination information.

The server maps each comparison-target information pair to an inconsistency-detected set, a consistent set, or an undetermined set using thresholds on the reliability values and class predictions.

Input: determination information for all comparison-target information pairs in a case.

Output: classification results and categorized lists of information units per case.

The server applies configurable decision rules that compare reliability values to predefined thresholds and stores category assignments in the database.

### Step 14

The server computes importance information and notification-priority information for each case.

The server aggregates the number and types of detected inconsistencies, evaluates their severity (for example, based on field type), and calculates an evaluation index representing overall risk or importance.

Input: categorized information units and determination information for all pairs in a case.

Output: importance scores, notification-priority levels, and evaluation indices for each case.

The server executes arithmetic operations on counts and weights, stores the resulting scores in case-level records, and may sort cases in memory by these values for later display.

### Step 15

The server constructs a prompt sentence that instructs a generative AI model to produce an explanation based on the comparison results.

The server composes a natural-language instruction and appends concise descriptions of key inconsistencies and their associated fields to form a single textual prompt.

Input: comparison-result information including structured information, determination information, and importance information for a case.

Output: a prompt sentence ready to be sent to a generative AI model.

The server concatenates an instruction segment, such as “You are a contract review assistant. Based on the following comparison between Document A and Document B, summarize all mismatches in clauses, amounts, and dates, and explain their potential impact on payment obligations and contract validity in plain English.” together with formatted details of mismatched fields.

### Step 16

The server sends the prompt sentence to a generative AI model and receives generated explanation information.

The server transmits the prompt sentence via an application programming interface to the model endpoint and waits for a response containing natural-language text.

Input: prompt sentence constructed from comparison-result information.

Output: explanation information in natural-language form describing detected content inconsistencies and their potential impact.

The server encodes the prompt as a request payload, sends it over a network protocol, parses the response text from the model, and stores it in association with the relevant case in the database.

### Step 17

The server generates display information and transmission information for presentation to the user.

The server prepares a case list view, detailed comparison view, and explanation view, embedding explanation information, highlighted mismatches, and importance scores into markup suitable for rendering.

Input: classification results, importance information, evaluation indices, and explanation information for each case.

Output: formatted display information for the terminal and optional transmission information such as notification messages.

The server constructs data structures containing layout instructions and references to specific document passages, and may generate email bodies or notification payloads containing summarized results.

### Step 18

The terminal receives the display information and renders it to the user.

The terminal's browser or client application interprets the markup, draws lists, tables, and highlighted text, and allows the user to navigate between cases and document views.

Input: display information transmitted from the server.

Output: visual presentation of cases, inconsistencies, and explanations on the terminal display.

The terminal executes rendering routines, manages user interface elements such as scrollbars and buttons, and may cache received data for smoother interaction.

### Step 19

The user reviews the displayed information, including detected inconsistencies and generated explanations.

The user examines side-by-side document sections, checks highlighted fields, and reads explanation information to understand the nature and impact of the inconsistencies.

Input: visual presentation of comparison results and explanations on the terminal.

Output: user decisions and judgments regarding the correctness and relevance of the system outputs (not yet sent to the server in this step).

The user may scroll, expand sections, or filter lists by severity using input actions on the terminal.

### Step 20

The user provides feedback to the system regarding determinations and explanations.

The user operates controls on the terminal to mark determinations as correct, incorrect, or uncertain, and to rate or comment on the usefulness of the explanation information.

Input: user selections and textual feedback entered on the terminal.

Output: feedback commands and data sent from the terminal to the server.

The terminal encodes user inputs into structured messages (for example, including case_id, pair_id, label, and comment) and transmits them to the server via the network.

### Step 21

The server stores the feedback as history information for later evaluation and model improvement.

The server parses received feedback, associates it with specific comparison-target information pairs and determination outputs, and records it in a history repository.

Input: feedback data from the terminal including evaluation information and validity information.

Output: stored history information linking user feedback to model outputs and cases.

The server updates dedicated tables that record feedback entries, timestamps, user identifiers, and references to model versions, enabling subsequent analysis and retraining.

### Step 22

The server optionally updates thresholds, evaluation indices, or retraining datasets based on accumulated history information.

The server analyzes feedback statistics to adjust decision thresholds or to select new training samples for future model updates.

Input: accumulated history information containing user feedback over multiple cases and time periods.

Output: updated configuration parameters (for example, thresholds) and prepared training datasets for model refinement.

The server executes statistical computations on feedback distributions, identifies patterns such as frequent false positives in particular feature ranges, and stores revised parameters or curated training sets for later use in model retraining.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional document verification workflows that compare electronic contract data with paper-based submissions rely heavily on manual review or on simple rule-based comparison engines. In such architectures, a server typically performs fixed-field string matching between an electronic contract record and text obtained from a scanned paper document. These approaches suffer from several technical limitations.

First, when the server performs only straightforward text comparison without robust natural language processing, the server is unable to accurately align semantically equivalent clauses that differ in wording, formatting, or layout. As a result, the server either misses true inconsistencies or generates excessive false positives, which degrades the reliability of automated inconsistency detection and forces human reviewers to perform additional manual checks.

Second, when the server applies optical character recognition (OCR) to document images, OCR errors and noise propagated directly into downstream comparison logic cause unstable and brittle behavior of the comparison process. Small OCR recognition errors, such as misrecognized numerals or symbols, can lead to incorrect mismatch flags, and the server lacks a mechanism to robustly interpret and reconcile the noisy text in view of the original electronic contract content.

Third, although generative AI models are capable of generating natural language explanations, naive integration of such models into the server-side pipeline often treats the models as general-purpose text generators without structured inputs or constraints. In such a configuration, the server cannot reliably control the generative AI model to focus on specific contract fields, clauses, and detected inconsistencies. This results in explanations that are incomplete, inconsistent with the underlying data, or difficult for users to understand in the context of concrete contract discrepancies.

Fourth, the server conventionally delivers uniform notification messages to user terminals regardless of a user's emotional state or cognitive load. When a user is in a stressed, confused, or highly distracted state, a dense and technical error report can overwhelm the user, leading to operational mistakes such as misinterpreting the discrepancy information or failing to correct critical inconsistencies. Existing systems typically lack any feedback loop that adapts the format, priority, or granularity of information presentation based on a dynamically estimated user state.

Fifth, these limitations collectively degrade key computer-centric performance metrics of the verification system, including processing throughput, error rate of automated inconsistency detection, effective bandwidth usage for transmitting repeatedly corrected document images, and overall usability of the human-computer interface. The server cannot efficiently exploit modern machine learning capabilities to both (i) structurally detect inconsistencies at a clause or field level and (ii) generate targeted, user-tailored guidance, all within a coherent, technically constrained workflow.

Accordingly, there is a need for an improved computer-implemented system and method in which a server cooperatively performs OCR, structured natural language analysis, and template-based field comparison, and then programmatically constructs prompt sentences as structured inputs to a generative AI model. There is also a need for the server to automatically generate machine-interpretable inconsistency data and user-facing natural language explanations, and to adapt the notification mode based on automatically estimated user emotion, thereby improving the technical operation of the document verification system as a whole.

The specific processing by the specific processing unit 290 of the data processing device 12 in Application Example 1 is realized by the following means.

The present invention provides a server comprising a processor and a memory storing instructions that, when executed by the processor, cause the server to perform character recognition processing on document image data acquired from a client device to extract character information; to perform an information analysis process on both electronic contract information and the extracted character information, the information analysis process including natural language processing and text information extraction to structure contents on a sentence or item basis and to determine presence or absence of required items and consistency or inconsistency of values based on predetermined item definitions or template information; to generate, based on comparison target information including the extracted character information, the electronic contract information, and a determination result of the information analysis process, a prompt sentence configured for input to a generative AI model so as to cause the generative AI model to generate natural language output information including explanation information or correction instruction information regarding detected inconsistencies; to generate inconsistency information including presence or absence of inconsistencies, locations of inconsistencies, types of inconsistencies, and importance levels, based on the information analysis process and the natural language output information generated by the generative AI model, and to transmit the inconsistency information and the natural language output information as notification information to a terminal device; and to execute emotion estimation processing to estimate an emotional state of a user from at least one of voice information, image information, and character input information, and to change a presentation mode or a priority of the notification information in accordance with the estimated emotional state. This enables the server to technically improve the accuracy and robustness of automated inconsistency detection between electronic and paper-based documents, to constrain and guide the operation of a generative AI model through structured prompt sentences so that generated explanations remain consistent with underlying comparison data, and to adapt the format and delivery of discrepancy notifications in real time based on user emotion, thereby enhancing system-level performance, reducing manual review load, and improving the effectiveness of human-computer interaction in contract verification workflows.

The term “electronic contract information” refers to digital data representing contractual clauses, terms, parties, amounts, dates, and other contract-related items stored in a machine-readable format in a storage device of an information processing system.

The term “paper-based document” refers to a physical medium bearing human-readable contract-related information, which is captured as an image by an image acquisition device for processing by an information processing system.

The term “document image data” refers to digital image data obtained by capturing at least a portion of a paper-based document using an image acquisition device such as an optical camera or scanner.

The term “attachment document data” refers to digital data corresponding to one or more documents submitted together with, or in association with, an approval or authorization procedure, including supporting or supplementary materials.

The term “image acquisition device” refers to hardware configured to capture visual information of a physical object or surface and output corresponding image data, including but not limited to a camera or scanner.

The term “character recognition process” refers to a computational procedure that analyzes image data to detect and identify graphical representations of characters and symbols and converts them into machine-readable character information, such as optical character recognition.

The term “character information” refers to digital data representing recognized textual characters, numerals, symbols, or strings obtained from image data by a character recognition process.

The term “information analysis process” refers to a set of computational operations that analyze, transform, and structure textual data, including natural language processing and text information extraction, for the purpose of comparison or interpretation.

The term “natural language processing” refers to a collection of computational techniques for analyzing and processing human language text, including operations such as tokenization, word segmentation, syntactic analysis, semantic analysis, and named entity recognition.

The term “text information extraction” refers to computational processing that identifies and extracts specific linguistic elements or structured fields, such as keywords, phrases, entities, or values, from unstructured or semi-structured text.

The term “sentence unit” refers to a minimal text segment that expresses a substantially complete statement in natural language, as segmented by natural language processing logic.

The term “item unit” refers to a logical text segment corresponding to a specific contract-related element, such as a field, clause, condition, amount, date, or party name, as defined by an item definition or template.

The term “predetermined item definitions” refers to configuration data specifying categories, formats, and relationships of contract-related items that are expected to appear in documents and are used as a basis for determining presence or absence and consistency of values.

The term “template information” refers to structured data representing a reference pattern or schema of a document, including predefined clauses, headings, and required fields used for comparison with actual document contents.

The term “required items” refers to document elements that must be present and valid according to predetermined item definitions or template information for a document to be considered complete or compliant.

The term “values” refers to specific data elements associated with items, such as numerical amounts, dates, identifiers, names, percentages, or textual parameters.

The term “consistency or inconsistency of values” refers to a determination result indicating whether corresponding values associated with the same item in different data sources are identical, equivalent within a tolerance, or different beyond a tolerance.

The term “comparison target information” refers to a collection of data used as input for comparison and analysis, including at least the electronic contract information, the extracted character information, and a determination result from the information analysis process.

The term “generative AI model” refers to a computational model implementing machine learning or artificial intelligence techniques configured to generate natural language or other data outputs based on input data or prompts.

The term “prompt sentence” refers to a structured text string or sequence provided as input to a generative AI model that instructs the model how to analyze, compare, or describe given information.

The term “natural language output information” refers to textual data generated by a generative AI model in a human-readable language, including explanation information and correction instruction information regarding document inconsistencies.

The term “explanation information” refers to natural language output that describes, clarifies, or interprets detected inconsistencies, including identification of affected items and reasons for the inconsistency.

The term “correction instruction information” refers to natural language output that provides guidance or recommendations on how to modify, update, or correct one or more document items to resolve detected inconsistencies.

The term “inconsistency information” refers to structured or semi-structured data that indicates presence or absence of inconsistencies, locations of inconsistencies, types of inconsistencies, and importance levels derived from analysis processes.

The term “locations of inconsistencies” refers to identifiers or coordinates indicating where in a document or dataset each inconsistency occurs, such as clause identifiers, line numbers, character offsets, or positional metadata.

The term “types of inconsistencies” refers to categories describing the nature of a mismatch, such as value mismatch, missing item, extra item, format deviation, or semantic modification.

The term “importance levels” refers to indicators of relative significance or severity of inconsistencies, such as priority ranks, risk levels, or impact scores.

The term “notification information” refers to data transmitted from a server to a terminal device that conveys inconsistency information and natural language output information to a user.

The term “terminal device” refers to a user-operated computing apparatus, such as a mobile device, tablet, or workstation, configured to send document image data to a server and receive and present notification information.

The term “emotion estimation processing” refers to a set of computational operations that analyze at least one of user-provided voice information, image information, or character input information to estimate an emotional state of a user.

The term “voice information” refers to audio data containing spoken utterances produced by a user and captured via a microphone or similar audio input device.

The term “image information” refers to visual data containing representations of at least a portion of a user, such as a face image or video frame, captured by an imaging device.

The term “character input information” refers to text data input by a user through an input interface such as a keyboard, touch screen, or handwriting interface.

The term “emotional state” refers to a classification or representation of a user's affective condition, such as calm, stressed, confused, or confident, as determined by emotion estimation processing.

The term “presentation mode” refers to a style or format in which notification information is displayed or conveyed to a user, including aspects such as layout, level of technical detail, highlighting, or summarization.

The term “priority of the notification information” refers to a relative ordering or urgency assigned to notification information for purposes of scheduling, alerting, or emphasis in a user interface.

The term “word segmentation processing” refers to a natural language processing operation that divides a text sequence into discrete word units based on language-specific rules or models.

The term “syntactic analysis processing” refers to a natural language processing operation that analyzes grammatical structure of text, including relationships among words and phrases such as subject, object, and modifiers.

The term “semantic analysis processing” refers to a natural language processing operation that interprets the meaning of text, including relationships between entities, roles, and events expressed in the text.

The term “named entity recognition processing” refers to a natural language processing operation that identifies and classifies specific entities in text, such as person names, organization names, locations, dates, and amounts.

The term “information units” refers to extracted segments or elements of text that correspond to specific semantic categories, such as party names, amounts, dates, periods, conditions, or clause headings.

The term “voice feature extraction processing” refers to computational analysis that derives characteristic parameters from audio signals, such as pitch, intensity, spectral features, and temporal patterns, for use in emotion estimation.

The term “facial expression feature extraction processing” refers to computational analysis that derives characteristic parameters from image data of a user's face, such as positions or movements of facial landmarks, for use in emotion estimation.

The term “writing style feature extraction processing” refers to computational analysis that derives characteristic parameters from textual input, such as vocabulary choice, sentence length, or punctuation patterns, for use in emotion estimation.

The term “presentation timing” refers to a temporal characteristic indicating when notification information is provided to a user, such as immediate, delayed, or scheduled delivery.

The term “presentation medium” refers to a communication channel or modality used to deliver notification information, such as a graphical display, audio output, or haptic feedback.

The term “level of detail of the notification information” refers to a degree of granularity or comprehensiveness in the content of notification information, such as summary-level output versus detailed clause-by-clause descriptions.

In one embodiment, a server, a terminal, and a user cooperate to implement the claimed system. The server includes at least one processor, a main memory, and a non-volatile storage device. The terminal includes an image acquisition device such as a camera, a microphone, a display, and an input interface. The user operates the terminal to capture paper-based documents that correspond to electronic contract information stored on the server.

The server uses general-purpose computing hardware such as a multi-core central processing unit and, in some embodiments, an accelerator such as a graphics processing unit. The server executes an operating system and middleware capable of running application software that performs optical character recognition, natural language processing, and machine learning inference. In specific implementations, the server uses an OCR engine such as a Tesseract-type engine or a cloud-based recognition service, and uses a machine learning framework such as a TensorFlow-type framework or a PyTorch-type framework to host a neural network implementing the generative AI model and the inconsistency detection model. The server further uses a database management system such as a relational database or a document database to store electronic contract information, OCR text, analysis results, and log data.

The terminal uses an operating system for mobile or desktop computing and executes a client application developed by using, for example, a native application framework. The terminal controls the image acquisition device to capture document image data of paper-based documents, such as printed contracts or approval forms, and transmits the image data to the server via a communication interface such as a wireless network interface or a wired network interface. The terminal displays notification information received from the server and accepts user operations in response to the notification.

The server stores electronic contract information as structured records in the database. In one example, the server stores, for each contract, a set of fields such as party identifiers, monetary amounts, dates, interest rates, addresses, clause texts, and corresponding clause identifiers. The server also stores template information and predetermined item definitions that specify required items, optional items, and expected formats for each item type. The server represents these definitions as data structures such as tables, key-value collections, or schema definitions.

The server receives document image data from the terminal and performs a character recognition process using the OCR engine. The server converts the raster image into a grid of pixels, segments regions likely to contain text, and detects character shapes. The server converts the detected shapes into character codes based on a trained character classifier. In one embodiment, the server configures the OCR engine with language-specific recognition models and character sets corresponding to the language of the contracts. The server outputs the recognized character information as a sequence of characters organized by line and paragraph, and may also include positional metadata indicating coordinates of each word on the page.

The server performs an information analysis process on the electronic contract information and on the character information extracted from the document image data. The server uses a natural language processing library to apply tokenization, word segmentation, syntactic analysis, semantic analysis, and named entity recognition. The server maps each token or phrase to an item unit according to the predetermined item definitions and template information. For example, the server identifies tokens that match numeric patterns along with context words indicating “amount,” “interest rate,” or “effective date,” and labels them as candidate values for corresponding items.

The server constructs a data structure that associates, for each item unit, one or more candidate values extracted from the electronic contract information and one or more candidate values extracted from the character information. The server then compares the values by applying rules and thresholds. For numeric values, the server compares the magnitudes and, if necessary, applies normalization rules such as decimal alignment or rounding. For textual values such as party names and clause headings, the server uses string similarity measures and semantic similarity measures derived from embeddings computed by a neural network encoder. The server determines whether each item is consistent or inconsistent, and also determines whether each required item is present or missing in either source.

In one embodiment, the server uses a neural network model distinct from the generative AI model to compute representations of sentences or clauses. This model may be configured as a transformer-based encoder with multiple self-attention layers, layer normalization, and feedforward sublayers.

The server trains this model prior to deployment using a dataset of aligned contract clauses and known discrepancies. The server uses a loss function such as a cross-entropy loss or a contrastive loss that encourages embeddings of matching clauses to be closer than embeddings of non-matching clauses. The server performs training on a training cluster and stores trained weights in the server storage. During inference, the server loads the weights and applies the model to generate embeddings of clauses from both electronic contract information and OCR text, and compares these embeddings using cosine similarity or Euclidean distance.

The server generates inconsistency information based on the comparison results. The inconsistency information includes, for each detected inconsistency, identifiers of the affected items, the values from each source, and metadata for location and importance. For example, the server may mark a discrepancy in interest rate as “high importance” and a discrepancy in formatting of a non-critical clause as “low importance.” The server aggregates these item-level results into a document-level determination indicating whether the documents are consistent overall.

The server uses a generative AI model to generate natural language output information that explains the inconsistencies and suggests corrections. In one embodiment, the generative AI model is a transformer-based sequence-to-sequence network with an encoder and a decoder, trained to generate explanation text conditioned on input prompts. The server stores the generative AI model parameters as numerical arrays representing weights of multi-head attention layers, feedforward networks, and embedding matrices. The server executes this model using a machine learning runtime that performs linear algebra operations such as matrix multiplications, layer normalization, and softmax computations.

The server constructs a prompt sentence as a structured input to the generative AI model. The server concatenates textual descriptions of the relevant clauses, summaries of the inconsistency information, and instructions for generating explanations. For example, the server may generate the following prompt sentence:

“Compare the following OCR-extracted contract text with the corresponding electronic contract text.

Using the discrepancy list below as a guide, generate a concise explanation for a non-expert user.

Highlight which clauses differ, by how much, and what corrections are recommended. OCR text: [OCR_TEXT_EXCERPT]. Electronic contract text: [ELECTRONIC_TEXT_EXCERPT]. Discrepancy list: [DISCREPANCY_DESCRIPTION].”

In another example, the server may use a shorter prompt sentence:

“Explain for a general user where this paper contract (OCR text) and this electronic contract do not match. List each mismatch as a bullet point with the item name, paper value, and electronic value.”

The server inputs the prompt sentence to the generative AI model. The model encodes the input tokens, attends over the encoded representation, and generates output tokens one by one according to learned probability distributions. The server decodes the token sequence into natural language output information. The server can control length, style, and content by constraining maximum output length, applying temperature scaling in the softmax function, or applying beam search parameters to prioritize more probable outputs. Because the server provides structured inconsistency information and field-level context as part of the prompt sentence, the generative AI model is guided to produce explanations that are aligned with the underlying data and not merely generic text.

The server then prepares notification information that includes the inconsistency information and the natural language output information. The notification information may be structured as a message for application-level communication. The server transmits the notification information to the terminal via a communication protocol such as HTTPS. The terminal receives the notification and displays the explanations and item-level discrepancies in a user interface.

The user views the notification on the terminal. The terminal may present, for example, side-by-side displays of the OCR text portion and the corresponding electronic contract clause, along with a natural language explanation such as:

“The interest rate in the paper document is 3.2%, but the electronic contract specifies 3.0%. Please correct the interest rate in the paper document to 3.0%.”

The user can use this information to revise the paper-based document, regenerate a corrected version from the electronic system, or otherwise rectify the inconsistency. By structuring the inconsistency data and explanation, the server reduces the time required for the user to identify and correct errors.

The server also executes emotion estimation processing to adapt the notification mode. The server receives, from the terminal, at least one of voice information, image information, or character input information produced by the user. The server uses a feature extraction module to convert these signals into numerical feature vectors. For example, the server extracts pitch, energy, and spectral features from voice signals; extracts facial landmark positions and muscle movement descriptors from image frames; and extracts sentence length statistics, vocabulary usage, and punctuation patterns from text input.

The server applies a classifier model to the feature vectors to estimate the user's emotional state. In one embodiment, the server uses a neural network classifier comprising fully-connected layers with nonlinear activation functions. The server trains the classifier using labeled datasets of feature vectors mapped to emotional categories such as calm, stressed, confused, or confident. The training uses a loss function such as cross-entropy and an optimization algorithm such as stochastic gradient descent or a variant. The server stores the trained classifier parameters and uses them at runtime to classify the emotional state based on incoming features.

Based on the estimated emotional state, the server modifies how the notification information is presented. For example, if the user is classified as stressed or confused, the server may instruct the terminal to display a simplified summary, highlight only the most critical discrepancies, and delay less important notifications. If the user is classified as calm and experienced, the server may provide a more detailed, technical report. The terminal may receive metadata from the server describing the selected presentation mode, priority, and level of detail.

This adaptive behavior is not limited to changing human workflow; it improves technical operation of the system. By tailoring the level of detail and timing of messages to the estimated emotional state, the server reduces repeated queries, re-uploads, and unnecessary image captures, thereby reducing network traffic and server load. The server also reduces the probability of user-induced corrections that would otherwise cause additional document submissions, which in turn reduces redundant OCR and analysis operations. This leads to more efficient use of computing resources, lower latency, and higher throughput for the document verification pipeline.

From a technical perspective, the described combination of OCR, natural language processing, structured comparison, and guided generative AI usage improves computer technology in several ways. The server transforms unstructured image data into structured, item-level representations using a particular data flow: image pixels are converted into character sequences; character sequences are transformed into tokens and item units; item units are compared according to schema-driven rules and learned similarity metrics; and the resulting inconsistency data is used as context to drive a generative AI model through explicit prompt sentences. This structured, multi-stage transformation allows the server to perform field-level, semantic-aware comparisons that conventional string-matching systems cannot perform at comparable accuracy or speed.

The use of a trained encoder model to compute clause embeddings and compare them numerically reduces the computational cost relative to exhaustive textual similarity checks and improves robustness to OCR errors and paraphrased wording. Because the embeddings capture semantic similarity rather than exact string matches, the server can tolerate minor recognition errors or wording variations while still correctly identifying corresponding clauses and inconsistencies. This improves both precision and recall of discrepancy detection, thereby reducing false positives and false negatives.

The explicit construction of prompt sentences that incorporate comparison target information and determination results provides a technical mechanism to constrain the generative AI model. Rather than using the generative AI model as a general-purpose conversational tool, the server uses it as a controlled component within a data processing pipeline. The server thereby ensures that the generative AI model operates on specific, structured inputs and produces outputs that are machine-usable in conjunction with the inconsistency information. This integration improves the reliability of the system, as the server can verify that generated explanations correspond to known discrepancies and can discard outputs that deviate from expected patterns.

In alternative embodiments, the server may implement variations of the neural network architectures and training methods. For example, the server may use a convolutional neural network for some feature extraction tasks, or may use a recurrent neural network for sequence modeling in place of, or in combination with, transformer layers. The server may employ different loss functions, such as margin-based losses for similarity learning, and may use data augmentation techniques, such as random substitution of synonyms or simulated OCR noise, during training to increase robustness to real-world input variability. The server may further adjust hyperparameters such as learning rate, batch size, and regularization coefficients to achieve desirable convergence and generalization.

In some embodiments, the server may offload parts of the processing to edge devices or to distributed computing nodes. For example, the terminal may perform preliminary OCR with a lightweight OCR engine, and the server may refine the recognition using a more complex model.

Alternatively, the server may distribute the generative AI computations across multiple nodes to handle high input volumes. The core data flow and integration of structured analysis with generative output remains consistent with the described embodiments.

In other variants, the server may adapt the prompt sentence templates based on document type, legal domain, or language. For instance, the server may maintain separate prompt patterns for financial contracts, employment agreements, or supplier contracts, and select the appropriate pattern based on metadata. The server may also vary the output language by specifying, in the prompt sentence, that explanations should be generated in a particular natural language.

The described embodiments are not limited to contract verification. The same architecture may be applied to other document comparison domains, such as regulatory filings, technical specifications, or compliance checklists, where electronic reference documents must be compared with printed or scanned submissions. In each case, the server applies the same principles: structured extraction of item units, schema-based comparison, embedding-based similarity evaluation, prompt-driven generative explanation, and emotion-aware adaptation of notification presentation. These techniques collectively improve the technical functioning of the computer system beyond mere automation of human review, by restructuring data, optimizing computational flows, and enabling more accurate, efficient, and context-aware processing of document inconsistencies.

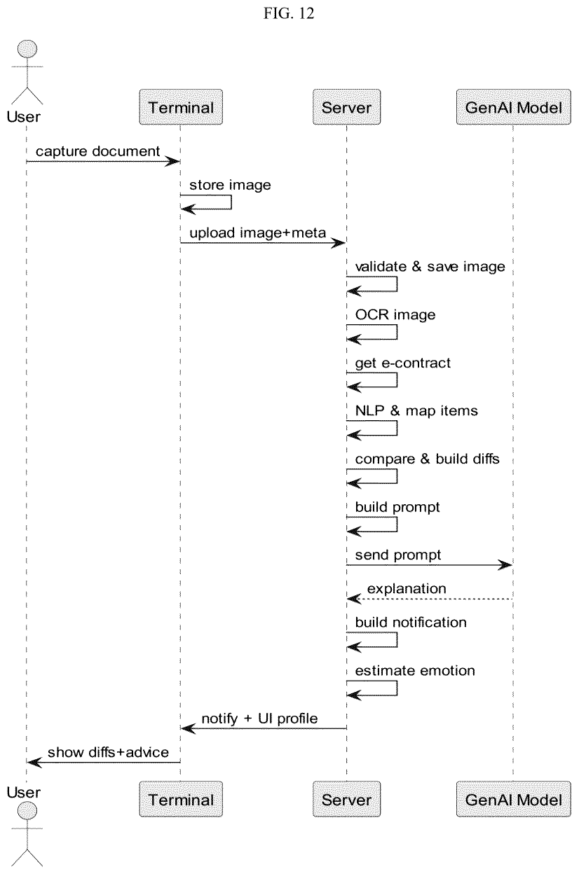

The following describes the processing flow using FIG. 12.

### Step 1

User operates the terminal to capture a paper-based document.

User aligns the document within a capture frame displayed on the terminal screen and activates a camera control (for example, by pressing a shutter button in an application).

Input: A physical paper document containing contract-related information.

Output: Raw document image data displayed in a preview on the terminal screen.

Terminal invokes the image acquisition device through an operating system camera API, converts the optical signal from the document into digital pixel data, and renders the resulting image for immediate confirmation by the user.

### Step 2

Terminal generates and stores a document image file.

Terminal receives the pixel buffer from the camera subsystem and encodes it into a compressed image format such as JPEG or PNG using an image codec library.

Input: Raw document image data from the camera subsystem.

Output: A stored document image file with associated metadata (for example, capture time, provisional document identifier).

Terminal writes the encoded image file into an application-specific storage area and records metadata in a local data structure so that the image can be located and transmitted to the server.

### Step 3

Terminal transmits the document image file and metadata to the server.

Terminal opens a secure communication channel to the server using a network stack and constructs a request message including the image file and document-related metadata such as a contract identifier and user identifier.

Input: Document image file and local metadata.

Output: A network request containing the image and metadata delivered to the server communication endpoint.

Terminal serializes the image as a binary payload (for example, multipart/form-data) and sends it over a network protocol such as HTTPS to a predefined server address.

### Step 4

Server receives and validates the uploaded document image data.

Server accepts the incoming request at a network interface, parses the request headers and body, and extracts the image binary and metadata fields.

Input: Network request containing document image data and metadata from the terminal.

Output: Validated document image binary and normalized metadata stored in server memory.

Server verifies authentication tokens, checks file size and format, and rejects or accepts the data based on defined validation rules; accepted data is then passed to subsequent processing modules.

### Step 5

Server stores the document image and registers it in a data repository.

Server assigns a unique identifier to the document image, saves the image into a storage subsystem, and creates a database record linking the image location with the metadata.

Input: Validated document image binary and metadata.

Output: Persistent storage record containing an image reference identifier and metadata.

Server writes the image file to a file system or object storage and inserts a record into a database table that includes fields such as document ID, user ID, contract ID, file path, and timestamp.

### Step 6

Server performs a character recognition process on the document image.

Server loads the stored image into an OCR engine, which segments text regions, identifies character shapes, and converts these shapes into character codes using a trained classifier.

Input: Stored document image referenced by an image identifier.

Output: Character information including recognized text strings and optional positional metadata.

Server invokes the OCR library, passes the image data as input, and receives as output a structured representation such as a list of lines and words together with recognition confidences and location coordinates.

### Step 7

Server retrieves corresponding electronic contract information.

Server accesses a contract repository using the contract identifier from the metadata to obtain the electronic contract fields and clause texts.

Input: Metadata including contract identifier and user identifier.

Output: Electronic contract information including structured fields and clause text content.

Server executes a query against a database or contract management system, retrieves records containing parties, amounts, dates, rates, clause texts, and clause identifiers, and loads them into application memory for analysis.

### Step 8

Server preprocesses OCR text and electronic contract text using natural language processing.

Server tokenizes both texts, segments them into sentences, normalizes character formats, and performs syntactic and semantic analysis along with named entity recognition.

Input: Character information from OCR and electronic contract text fields.

Output: Structured text representations including tokens, sentence boundaries, and labeled entities.

Server applies natural language processing algorithms to transform raw text into data structures such as token lists and entity lists, facilitating subsequent alignment at the level of items and clauses.

### Step 9

Server maps text segments to item units based on predetermined item definitions and template information.

Server examines the structured text and associates each detected token or phrase with a logical item type such as amount, date, party identifier, or clause heading, by matching patterns and context against schema rules.

Input: Structured text representations and configuration data defining item types and templates.

Output: Item-unit mappings that link specific text segments to item categories and identifiers.

Server runs rule-based pattern matchers and context-based classifiers that assign item labels to tokens, producing a mapping structure that can be used to align items across the OCR text and the electronic contract.

### Step 10

Server compares values associated with corresponding item units.

Server aligns item units from the OCR-derived data with item units from the electronic contract, then measures equality or discrepancy of their values according to item-specific comparison rules.

Input: Item-unit mappings for OCR text and electronic contract text.

Output: Preliminary comparison results indicating matches, mismatches, missing items, and extra items.

Server executes numeric comparison routines for quantities and dates, string similarity computations for names and headings, and threshold-based logic that classifies each aligned item pair as consistent or inconsistent.

### Step 11

Server computes semantic similarity between clauses using an encoder model.

Server encodes sentences or clauses from both OCR text and electronic contract text into high-dimensional embedding vectors using a trained neural network encoder, then calculates similarity metrics between corresponding embeddings.

Input: Clause-level segments derived from the structured text and a trained encoder model.

Output: Similarity scores for clause pairs and alignment information for semantically related clauses.

Server feeds tokenized clause sequences into the encoder, collects output vectors, and computes cosine similarity or other distance measures; these metrics are then used to refine the identification of corresponding clauses and detect paraphrased discrepancies.

### Step 12

Server generates inconsistency information from comparison and similarity results.

Server combines item-level comparison outcomes and clause-level similarity scores to construct inconsistency records that specify the type, location, and severity of each detected discrepancy.

Input: Preliminary comparison results and clause similarity metrics.

Output: Inconsistency information including presence or absence of inconsistencies, affected items, and importance levels.

Server aggregates results into a structured form, such as a collection of objects each describing an item name, values from each source, clause reference, and a computed importance rank based on rule-based or learned criteria.

### Step 13

Server constructs a prompt sentence for a generative AI model.

Server converts the inconsistency information, excerpts of OCR text, and excerpts of electronic contract text into a prompt sentence that instructs the generative AI model how to generate an explanation.

Input: Inconsistency information, OCR text excerpts, electronic contract text excerpts, and prompt template definitions.

Output: A prompt sentence formatted as natural language and containing structured description of discrepancies.

Server assembles strings by inserting placeholders with concrete values, such that the resulting prompt may be, for example: “Explain for a general user where this paper contract (OCR text) and this electronic contract do not match. List each mismatch as a bullet point with the item name, paper value, and electronic value.”

### Step 14

Server inputs the prompt sentence into the generative AI model and generates natural language output information.

Server tokenizes the prompt sentence, feeds the tokens into a transformer-based sequence model, and decodes the resulting output token sequence into human-readable text.

Input: Prompt sentence and model parameters of the generative AI model.

Output: Natural language output information including explanation information and correction instruction information.

Server performs embedded vector computations, attention operations, and probability-based token selection (for example, using beam search), then converts output token IDs back into characters to produce explanatory paragraphs or bullet lists.

### Step 15

Server integrates natural language output with inconsistency information into notification information.

Server merges the generated explanation text with the structured inconsistency records, packaging them into a single data object that can be transmitted to the terminal.

Input: Inconsistency information and natural language output information.

Output: Notification information including both machine-readable discrepancy data and human-readable explanations.

Server formats the data according to an application message schema and ensures that item references present in explanations can be correlated with specific inconsistency records.

### Step 16

Server estimates the user's emotional state from multimodal input.

Server receives one or more of voice information, image information, and character input information from the terminal and extracts feature vectors using signal processing and pattern recognition algorithms.

Input: User-related signals such as audio samples, image frames, and typed text.

Output: An estimated emotional state label or score vector representing user affect.

Server processes audio to compute pitch and energy features, processes images to locate facial landmarks and expression intensities, and processes text to measure style indicators; the server then applies a trained classifier to these features to output an emotion classification.

### Step 17

Server adapts notification presentation parameters based on the emotional state.

Server uses the estimated emotional state to select a presentation mode, such as a concise summary versus a detailed report, and a priority level for displaying notifications on the terminal.

Input: Estimated emotional state and notification information.

Output: Adapted presentation parameters attached to the notification information.

Server applies decision logic that maps emotional categories to presentation profiles; for example, for a stressed state, the server sets a profile with simplified language and emphasis on critical discrepancies.

### Step 18

Server transmits the adapted notification information to the terminal.

Server encapsulates the notification information and presentation parameters into a response message and sends it over the network channel to the terminal.

Input: Notification information enhanced with presentation profiles.

Output: A network response containing all data needed for user-facing display.

Server serializes the data structure, assigns appropriate response codes, and dispatches the message through a communication protocol such as HTTPS.

### Step 19

Terminal renders the notification information according to the presentation parameters.

Terminal receives the notification message, parses the data, and constructs user interface elements that show discrepancies and explanations in the specified format.

Input: Notification information and presentation parameters from the server.

Output: A visual (and optionally auditory) presentation of discrepancies on the terminal display or through other output devices.

Terminal arranges layout components such as lists, highlight markers, and text areas, and may use different font sizes, colors, or levels of detail based on the presentation profile.

### Step 20

User reviews the discrepancies on the terminal and performs corrections on the documents.

User reads the explanation and inconsistency details, identifies incorrect items on the paper-based document or within the electronic contract, and updates the relevant content using available tools or processes.

Input: Visualized discrepancy information and natural language guidance.

Output: Corrected or newly prepared document instances that better match the electronic contract information.

User may, for example, adjust a printed interest rate, correct a date field, or request a revised electronic contract, thereby closing the loop between server-side analysis and real-world document correction.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional document reconciliation systems that compare information between physical documents and electronic records typically rely on rule-based text matching or simple keyword searches. Such systems suffer from several technical deficiencies. First, optical character recognition and basic text mining often produce noisy or partially structured data that must be manually checked, resulting in high latency, increased processor load due to redundant passes over the same data, and frequent human intervention. Second, conventional architectures treat natural language processing, structured comparison, and inconsistency judgment as independent stages without unified feature representations, which leads to inefficient memory usage, duplicated parsing, and limited scalability when the number of documents and comparison fields increases. Third, existing systems that incorporate machine learning models for inconsistency detection usually expose only raw scores, forcing downstream application logic or human operators to infer the meaning of the scores, thereby limiting the usability of the system and increasing the number of round-trips between components. Fourth, generative artificial intelligence models, when used at all, are typically applied in an ad hoc manner, without structured prompt construction tied to the underlying comparison data and model outputs, causing unstable responses, unpredictable processing times, and poor reproducibility across executions. Fifth, notification mechanisms in such systems are static and do not adapt to a user's cognitive load or emotional state, which can result in information being overlooked or misinterpreted, and can require additional clarification cycles that degrade overall system throughput.

Accordingly, there is a need for a technical solution that (i) integrates character recognition, natural language processing, and machine-learning-based inconsistency detection into a unified processing pipeline, (ii) generates structured comparison data in a form directly consumable by both a trained determination model and a generative artificial intelligence model, (iii) automatically produces natural-language explanations of detected inconsistencies without requiring additional custom business logic, and (iv) dynamically adjusts notification priority, format, and content based on an estimated user emotional state. Such a solution should improve processor efficiency, reduce unnecessary data transfers and re-parsing operations, stabilize inference behavior of the generative artificial intelligence model by using systematically constructed prompt sentences, and enhance the overall reliability and usability of computer-implemented document reconciliation.

The specific processing by the specific processing unit 290 of the data processing device 12 in Example 2 is realized by the following means.

The present invention provides a server comprising a processor and a memory storing instructions that, when executed by the processor, cause the server to acquire character information derived from image information of a physical medium and electronic information stored in a storage device, to analyze the character information and the electronic information by using a natural language processing program to extract key information, to generate structured comparison data by associating values derived from the physical medium and values derived from the electronic information for respective comparison items, to input the structured comparison data into a trained determination model constructed by a machine learning program to output for each comparison item a consistency index and a content inconsistency determination result, to generate analysis result information including content inconsistency items and associated values and consistency indices, to construct and output a prompt sentence that embeds the analysis result information as structured data and that instructs a generative artificial intelligence model to generate a user-oriented natural language explanation of the content inconsistencies, to input the prompt sentence and the analysis result information into the generative artificial intelligence model to obtain the user-oriented explanation, and to analyze user input information by using an emotion estimation program so as to adjust at least one of a notification priority, a presentation format, and an expression content of a notification regarding the content inconsistencies based on an estimated emotional state. This enables a computer-implemented document reconciliation system to perform end-to-end automated inconsistency detection and explanation with reduced manual intervention, to improve processing efficiency by avoiding redundant parsing and ad hoc application logic, to stabilize and structure interactions with a generative artificial intelligence model through systematically generated prompt sentences, and to dynamically optimize user notifications in accordance with the user's emotional state, thereby enhancing the technical performance and usability of the overall system.

The term “processor” refers to a hardware execution unit, such as a central processing unit or a computing core, that executes instructions stored in a memory to perform operations specified by programs.

The term “memory” refers to a hardware storage component, such as a volatile memory device or a non-volatile memory device, that stores instructions and data for access by a processor.

The term “physical medium” refers to a tangible recording medium, such as a sheet-like substrate or another physical carrier, on which human-readable information is recorded.

The term “image acquisition device” refers to a hardware device, such as a scanner or a camera, that optically captures an image of information recorded on a physical medium and outputs digital image data.

The term “image information” refers to digital data representing a captured image of information recorded on a physical medium, including, for example, pixel values or encoded image files.

The term “terminal apparatus” refers to an electronic device operated by a user, such as a client device or a user terminal, that communicates with a server apparatus and executes application programs.

The term “server apparatus” refers to an electronic device or a group of electronic devices, such as one or more server computers, that provide processing functions and services to one or more terminal apparatuses over a communication network.

The term “user terminal” refers to a terminal apparatus that presents information to a user and receives input from the user in connection with document reconciliation processing.

The term “character recognition program” refers to software that performs optical character recognition on image information to detect and convert characters in the image information into machine-readable character information.

The term “character information” refers to digital data representing characters or text extracted from image information, typically encoded in a machine-readable character encoding format.

The term “electronic information” refers to information stored in an electronic format in a storage device, such as structured records, text fields, or other data elements that describe contents of a document or an associated transaction.

The term “storage device” refers to a hardware component or subsystem, such as a disk device, a solid-state storage device, or a network-attached storage system, that stores electronic information in a non-transitory manner.

The term “natural language processing program” refers to software that analyzes character information or electronic information expressed in a natural language to perform operations such as tokenization, sentence segmentation, part-of-speech tagging, and information extraction.

The term “key information” refers to information elements extracted from character information or electronic information, including, for example, clause information, numerical information, date information, and party information that are relevant to inconsistency determination.

The term “clause information” refers to key information indicating an identifiable provision or section in a document, such as an item number, heading, or label associated with a contractual term.

The term “numerical information” refers to key information representing quantities or numeric values, including, for example, amounts, counts, percentages, or other numbers appearing in a document.

The term “date information” refers to key information representing temporal data, including, for example, dates or times associated with execution, validity, or other events described in a document.

The term “party information” refers to key information identifying an entity involved in a document or transaction, such as a person, an organization, or another participant.

The term “association rule” refers to predefined or learned correspondence information that specifies how elements of key information derived from a physical medium are to be associated with corresponding elements of electronic information to form comparison items.

The term “comparison item” refers to a unit of comparison that associates a value derived from key information of a physical medium with a value derived from electronic information for the purpose of determining consistency or inconsistency.

The term “structured data” refers to data arranged in a predefined format, such as a record or a data structure, that associates, for each comparison item, a value derived from a physical medium with a value derived from electronic information.

The term “machine learning program” refers to software that trains and executes a computational model based on training data so as to perform tasks such as classification, regression, or scoring for inconsistency determination.

The term “trained determination model” refers to a model generated by a machine learning program using training data, the model being configured to receive structured data as input and output information such as a consistency index and a content inconsistency determination result for each comparison item.

The term “consistency index” refers to a quantitative measure output by the trained determination model that indicates a degree of consistency between a value derived from a physical medium and a value derived from electronic information for a given comparison item.

The term “content inconsistency determination result” refers to a determination, produced by the trained determination model, that indicates whether contents associated with a comparison item are consistent, inconsistent, or fall into another classification.

The term “analysis result information” refers to information generated based on comparison result data, the information including at least content inconsistency items, a value on a physical medium side, a value on an electronic information side, and a consistency index.

The term “comparison result data” refers to data that aggregates, for each comparison item, outputs of the trained determination model, including at least a consistency index and a content inconsistency determination result.

The term “content inconsistency item” refers to a comparison item for which the content inconsistency determination result indicates that values derived from a physical medium and electronic information are not consistent.

The term “generative artificial intelligence model” refers to a model, such as a generative language model, that generates new data, including natural language text, in response to an input comprising prompt information and optional structured data.

The term “prompt sentence” refers to a text sequence or instruction that is provided as input to a generative artificial intelligence model to specify a task, context, or constraints for generating an output.

The term “user-oriented explanation sentence” refers to a natural language text generated for presentation to a user, the text explaining content inconsistencies and optionally recommended actions in a form suitable for human comprehension.

The term “user input information” refers to information obtained from a user, including, for example, voice information, image information, or character input information, which may be used for emotion estimation or interaction control.

The term “emotion estimation program” refers to software that analyzes user input information to estimate an emotional state of a user, such as tension, confusion, or anxiety.

The term “emotional state” refers to an estimated psychological or affective condition of a user, inferred by the emotion estimation program from user input information.

The term “notification priority” refers to a parameter that defines the urgency or importance level assigned to a notification regarding content inconsistencies for scheduling or presentation control.

The term “presentation format” refers to a mode or style of presenting information to a user, including, for example, visual layout, level of detail, or interaction modality.

The term “expression content” refers to textual or symbolic content used in a notification, including wording, tone, and amount of detail, which may be adjusted based on an estimated emotional state.

In one embodiment, a server cooperates with one or more terminals and an image acquisition device to implement the claimed system. The server includes at least one processor, a main memory, a non-volatile storage device, and a network interface. The terminal includes at least one processor, a memory, a display device, one or more input devices, and a communication interface. The image acquisition device is, for example, a document scanner or camera that acquires image information of a paper document serving as a physical medium.

The user places a physical document, such as a paper contract, on the image acquisition device. The terminal controls the image acquisition device through a driver program running on an operating system such as a general-purpose desktop operating system or a mobile operating system. The terminal configures scan parameters, such as resolution and color mode, and causes the image acquisition device to output raster image data of the physical document. The terminal stores the image data in a storage device, for example as a TIFF, JPEG, or PDF file, and associates metadata including a document identifier, a user identifier, and a timestamp.

The terminal executes a character recognition program, for example an optical character recognition engine such as a general OCR library or an open-source OCR engine, to convert the raster image data into character information. The terminal loads the image file into the OCR engine, sets language and page segmentation parameters, and invokes recognition routines that perform low-level image processing, connected-component analysis, and character classification using pre-trained character models. The terminal receives recognized text in a machine-readable encoding and optionally receives layout coordinates describing positions of text lines and words. The terminal then transmits the character information and associated metadata to the server over a communication network using a protocol such as HTTPS.

The server receives the character information and stores it in a storage device together with electronic information obtained from an external data source, such as an electronic workflow system or document management system. The server normalizes the character information by performing operations including character set normalization, whitespace normalization, and removal of obvious recognition artifacts. The server stores both the raw character information and the normalized character information so that subsequent processing stages may reuse preprocessed data without repeating the same operations, thereby reducing processor load and memory bandwidth usage.

The server executes a natural language processing program to analyze the normalized character information and the electronic information. The server loads a natural language processing library, such as a general statistical or neural natural language processing toolkit, and applies tokenization, sentence segmentation, part-of-speech tagging, and named entity recognition. The server identifies key information, including clause labels, numerical expressions, date expressions, and entity names representing parties. The server applies domain-specific parsing rules that detect patterns such as “Clause [identifier]: [text]” and map them to structured records. For example, the server generates a record containing fields for a clause identifier, a numerical amount, a date, and a party name. The server stores these records as structured data associated with the document identifier.

The server also analyzes the electronic information using the same or a compatible natural language processing program. When the electronic information is already structured, for example in key-value pairs, the server normalizes field names and value formats to a canonical schema. For numerical values, the server converts different currency expressions to a common numeric representation and scales units when necessary. For date values, the server converts multiple date notations to a unified internal date format. This normalization allows the server to compare values at a data level rather than as arbitrary character strings, improving both performance and accuracy.

The server generates comparison items by applying association rules that correlate elements of key information derived from the physical document with corresponding elements in the electronic information. The server uses a mapping configuration that defines, for each comparison item, which source fields on the physical side and which source fields on the electronic side are to be paired. The server then generates structured data where each record contains a field identifier, a physical-side value, an electronic-side value, and contextual metadata such as the document section and data type.

The server stores this structured data in memory in a vectorized representation that can be efficiently supplied to a machine learning model, thereby avoiding repeated parsing during inference.

The server executes a machine learning program implementing a trained determination model that receives the structured comparison data and outputs, for each comparison item, a consistency index and a content inconsistency determination result. In one embodiment, the trained determination model is implemented as a neural network that includes an embedding layer for token representations, one or more sequence processing layers such as bidirectional recurrent layers or self-attention layers, and one or more fully connected layers that output probability values for classes such as “consistent,” “inconsistent,” and “uncertain.” The server encodes textual values by applying tokenization and mapping tokens to embedding vectors. The server encodes numeric values by normalizing them to scalar or vector representations, for example by scaling to a standard range and, where appropriate, including difference values between physical-side and electronic-side numbers as additional features.

The server trains the determination model in a separate training phase using labeled examples of comparison items. During training, the server minimizes a loss function, such as a cross-entropy loss, between model predictions and ground-truth labels. The server updates model parameters using an optimization algorithm such as stochastic gradient descent or a variant with adaptive learning rates. The server may perform data augmentation, such as adding controlled noise, random format variations, or slightly perturbed numerical values, to increase the robustness of the model to OCR errors and formatting differences. After training, the server stores the trained model parameters in non-volatile memory. During inference, the server loads the trained model into main memory and executes the model using a numerical computation library. The model architecture, feature encoding, and training procedure are designed so that the model can leverage both textual context and numeric relations, providing higher precision and recall than simple string matching or rule-based comparison.

The server computes, for each comparison item, a consistency index representing a probability or score of consistency, and a content inconsistency determination result obtained by applying a threshold or decision rule to the output probabilities. The server aggregates these outputs to generate comparison result data. The server then generates analysis result information that includes, for each content inconsistency item, the field identifier, the physical-side value, the electronic-side value, the consistency index, and, optionally, contextual explanations such as the section of the document in which the inconsistency occurs. The server stores the analysis result information and prepares it for presentation to the terminal.

The server further uses a generative AI model to generate a user-oriented explanation of the detected inconsistencies. In one embodiment, the server connects to an external or internal generative AI engine implementing a large language model. The server constructs a prompt sentence that encodes both instructions and structured content. For example, the server generates a prompt sentence such as:

“You are an assistant that checks inconsistencies between a scanned paper contract and electronic approval data.

The following are field-by-field comparison results:
Field: Clause A/Amount
Physical document value: 1,000,000 JPY
Electronic record value: 1,200,000 JPY
Consistency index: 0.05 (inconsistent)

Explain in clear business language what is inconsistent and what action the user should consider.”

The server embeds the analysis result information into the prompt sentence in a deterministic order and format, so that the generative AI model receives a consistent input structure across executions.

By fixing prompt templates and field ordering, the server reduces variance in generated outputs and enables caching and reuse when the same comparison results are requested again. The server transmits the prompt sentence to the generative AI model, receives a natural-language explanation sentence, and stores the explanation together with the analysis result information.

In another example, the server generates a prompt sentence for a document-wide explanation, such as:

“Compare the key terms in the scanned contract text and the electronic approval data below.

List all items where the values are different, and explain them briefly for a non-technical business user.

Scanned contract key items: Clause A amount: 1,000,000 JPY; Effective date: 2026 Feb. 1.

Electronic approval key items: Clause A amount: 1,200,000 JPY; Effective date: 2026 Feb. 1.”

The server may select different prompt templates based on the number of inconsistent fields, the document type, or a user preference, and may limit the maximum length of the generated explanation to meet latency constraints.

The server additionally executes an emotion estimation program that analyzes user input information, such as voice, facial image, or typed text on the terminal, to estimate an emotional state.

For instance, the terminal may capture audio using a microphone and transmit feature representations to the server. The server extracts prosodic features such as pitch, energy, and speaking rate, and applies a classifier model that outputs probabilities for emotional categories such as tension, confusion, or calmness. Similarly, the terminal may capture facial images via a camera; the server then applies a facial feature extractor and an emotion classifier. For textual user input, the server may use sentiment analysis to infer whether the user is frustrated or confused.

The server uses the estimated emotional state to adapt notification priority, presentation format, and expression content. For example, when the emotional state indicates confusion, the server selects a prompt sentence that instructs the generative AI model to produce a simpler and more detailed explanation, such as:

“The user may be confused.

Explain the following inconsistency in very simple and clear language, and include specific recommended next steps.
Field: Clause A/Amount
Physical document value: 1,000,000 JPY
Electronic record value: 1,200,000 JPY.”

The server therefore adjusts the parameters of the generative AI interaction, such as requested tone, detail level, and length, based on a measured state rather than a fixed template, which adapts the system's behavior to the user's cognitive condition and reduces the chance that critical information is overlooked.

The server transmits the analysis result information and the generated explanation sentences to the terminal. The terminal presents the information on a display device, for example as a web page showing inconsistent items highlighted in color and accompanied by explanations. The user may navigate the display to inspect each inconsistency. The terminal may also provide interactive controls enabling the user to mark items as resolved or to initiate correction workflows in external systems.

The described configuration results in several technical effects. Because the server generates and stores structured comparison data as explicit records linking physical-side and electronic-side values, the determination model can operate on pre-encoded features without re-parsing original text, which reduces computational redundancy and memory usage. Because the model architecture is designed to jointly encode textual context and numeric differences, the server can distinguish between harmless formatting variations and true substantive mismatches, increasing accuracy compared to simple string comparison. Because prompt sentences for the generative AI model are constructed programmatically from structured analysis results, the system enforces consistent prompt patterns that stabilize model behavior and reduce the need for manual tuning. This improves repeatability and lowers variance in output, which in turn enables caching and reuse of explanation texts. The emotion estimation and adaptive notification further reduce the number of user interactions required to understand and act on inconsistencies, thereby decreasing overall processing time and network traffic associated with repeated clarification requests.

In a variant embodiment, the terminal instead of the server performs part of the natural language processing and structured data generation, and transmits only compact structured records to the server. In such a case, the server can skip expensive parsing and focus on running the trained determination model and generative AI interactions. This architecture reduces the volume of data transmitted over the network and shifts part of the computational load to client devices when network resources are constrained.

In another embodiment, the determination model is implemented not as a sequence model but as a graph-based neural network that explicitly models relationships between fields across a document, such as dependencies between clauses or consistency of amounts across multiple sections. The server then constructs a graph representation where nodes represent comparison items and edges represent logical or semantic relationships. The model propagates information along edges and outputs a consistency index for each node. This modification allows the system to detect subtle inconsistencies that depend on cross-field relationships, further improving accuracy.

In another embodiment, the server uses a rule-based pre-filter that quickly flags obviously consistent items using efficient numeric comparison and hashing of normalized strings, and supplies only ambiguous or complex items to the trained determination model. This reduces the number of items processed by the more computationally expensive neural network, thereby improving throughput and reducing energy consumption. The server may tune pre-filter thresholds to balance speed and accuracy according to system constraints.

These embodiments demonstrate that the system does not merely automate human reading and comparison, but instead implements specific technical structures and algorithms that improve the functioning of the computer system itself: by introducing explicit intermediate data structures for comparison items, by using specialized neural model architectures and feature encodings for inconsistency detection, by enforcing structured prompt sentence formats to stabilize generative AI output, and by dynamically adapting presentation based on machine-estimated emotional state. The resulting system achieves increased processing speed, higher inconsistency detection accuracy, reduced manual review effort, improved data management, and lower communication and computation overhead compared with conventional document reconciliation techniques.

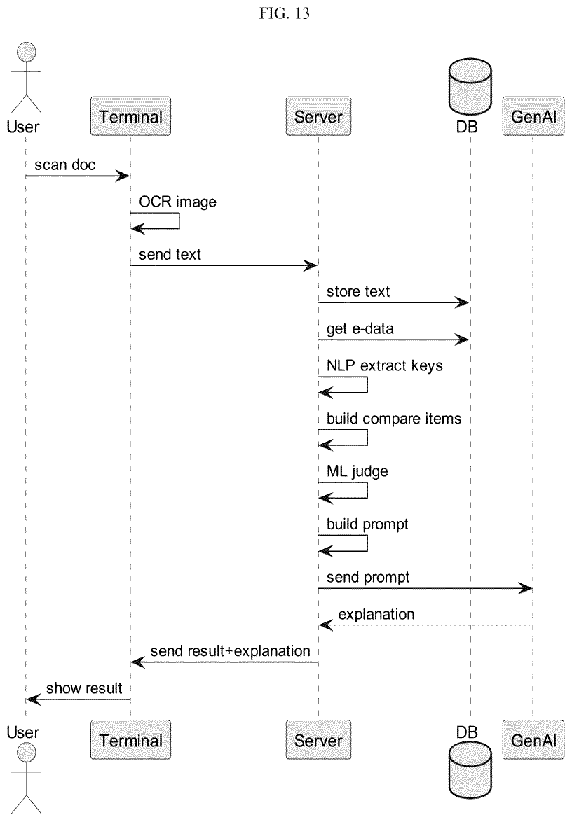

The following describes the processing flow using FIG. 13.

### Step 1

The user places a physical document on an image acquisition device and starts a scan operation from the terminal.

Input: A physical medium (paper document).

Output: Raw image data (for example, a TIFF, JPEG, or PDF file).

The terminal controls the image acquisition device via a driver, sets parameters such as resolution and color mode, and commands the device to capture the document. Based on the analog optical input, the image acquisition device converts reflected light into digital pixel values. The terminal receives the pixel stream, encodes it into an image file format, assigns a document ID, and stores the file in local storage.

### Step 2

The terminal executes a character recognition program on the stored image file to obtain character information.

Input: Raw image data associated with a document ID.

Output: Character information (recognized text and optionally layout metadata).

The terminal loads the image file into an OCR engine, sets language and page segmentation parameters, and performs binarization, line detection, and character segmentation. The terminal then uses a pre-trained character classifier to map image patches to character codes. The OCR engine aggregates characters into words and lines, producing machine-readable text and, optionally, coordinate data. The terminal packages the character information together with the document ID and sends it to the server over a secure communication channel.

### Step 3

The server receives the character information and stores it along with metadata in a storage device.

Input: Character information and document ID transmitted from the terminal.

Output: Persisted character records and normalized text data.

The server validates the received data, checks the document ID, and writes the raw text to a text storage area. The server applies normalization operations, such as converting character encodings, unifying full-width and half-width characters, and removing obvious OCR artifacts. The server saves both the raw and normalized versions and updates a document status field to indicate that text extraction is complete.

The server obtains corresponding electronic information for the same document from an external system or internal database.

Input: Document ID and linkage information (for example, an approval request ID).

Output: Electronic information in a structured or semi-structured format.

The server queries an external application programming interface or a local database using the linkage information. The server receives electronic records, which may include key-value pairs, table rows, and free-form text fields. The server parses the electronic records into an internal representation, and stores them in association with the same document ID.

### Step 5

The server executes a natural language processing program on the normalized character information to extract key information from the physical document.

Input: Normalized character information for a document.

Output: Structured key information records derived from the physical document.

The server tokenizes the text into sentences and words, performs part-of-speech tagging, and applies named entity recognition. The server uses pattern-matching rules to detect clause identifiers, numerical expressions, date expressions, and party names. For each detected unit, the server creates a record containing the field type, text span, normalized value, and location in the document. The server stores these records in a key-information table linked to the document ID.

### Step 6

The server analyzes the electronic information using the natural language processing program and normalization routines.

Input: Electronic information associated with the document ID.

Output: Structured key information records derived from the electronic information.

The server reads fields from the electronic records and, when necessary, applies tokenization and entity extraction to free-form text. The server normalizes numerical expressions by converting different formats into a common numeric type and normalizes date expressions into a unified date representation. The server maps electronic fields to internal field identifiers and stores them as structured key information records.

### Step 7

The server generates comparison items by associating physical-side key information with electronic-side key information according to predefined association rules.

Input: Key information records from the physical document and from the electronic information.

Output: Structured comparison data records for each comparison item.

The server loads an association rule set that specifies, for each logical field, which key information records to pair. The server matches physical-side and electronic-side records by field identifier, clause label, or other matching criteria. For each match, the server builds a comparison record that includes a field name, a physical-side value, an electronic-side value, data type, and contextual metadata. The server stores these comparison records in memory and optionally in persistent storage, ready for model inference.

### Step 8

The server converts the structured comparison data into feature vectors and supplies them to the trained determination model.

Input: Structured comparison data records.

Output: Feature vectors suitable for input to a neural network.

The server encodes textual values by tokenizing them and mapping tokens to embedding indices.

The server retrieves pre-computed embedding vectors from a parameter store. For numerical values, the server generates scalar features such as the normalized magnitude, the absolute difference between physical and electronic values, and ratio features. The server concatenates these text and numeric features into fixed-length vectors per comparison item and batches them to form model input tensors.

### Step 9

The server executes the trained determination model to calculate a consistency index and a content inconsistency determination result for each comparison item.

Input: Batched feature vectors representing comparison items.

Output: For each comparison item, a consistency index and a classification label.

The server loads the trained model parameters into memory and invokes a numerical computation library to perform forward propagation through the model layers. The model may include embedding layers, one or more recurrent or attention layers, and fully connected output layers. For each input vector, the model outputs a probability distribution over classes and a continuous score representing consistency. The server interprets the output by applying threshold rules or decision logic to assign labels such as “consistent,” “inconsistent,” or “uncertain.” The server then creates comparison result data that attaches the computed consistency index and label to each comparison record.

### Step 10

The server generates analysis result information summarizing detected content inconsistencies.

Input: Comparison result data for all comparison items in a document.

Output: Analysis result information including content inconsistency items and associated values.

The server scans the comparison result data and selects items whose label indicates an inconsistency or low confidence. For each such item, the server compiles a record containing the field name, physical-side value, electronic-side value, consistency index, and document context. The server aggregates these records into an analysis result data structure and stores it with the document ID.

The server marks the document status as analyzed.

### Step 11

The server constructs a prompt sentence for a generative AI model based on the analysis result information.

Input: Analysis result information for a document.

Output: A prompt sentence encoding instructions and comparison details.

The server selects a prompt template depending on the number and type of inconsistent items. The server inserts field names, physical-side values, electronic-side values, and consistency indices into the template in a fixed order. For example, the server generates a prompt sentence such as:

“You are an assistant that explains inconsistencies between a scanned paper document and electronic records.
Field: Clause A/Amount
Physical value: 1,000,000 JPY
Electronic value: 1,200,000 JPY
Consistency index: 0.05

Explain what is inconsistent and what action the user should consider.”

The server outputs the finalized prompt sentence and associates it with the document ID for subsequent model interaction.

### Step 12

The server sends the prompt sentence and the analysis result information to the generative AI model and obtains a user-oriented explanation sentence.

Input: Prompt sentence and analysis result information.

Output: A natural-language explanation sentence describing the inconsistencies.

The server transmits the prompt sentence and, if required, supporting details to a generative AI model endpoint. The generative AI model processes the prompt and returns a generated text. The server receives the generated explanation, trims or post-processes it according to length and formatting constraints, and stores the user-oriented explanation sentence together with the corresponding analysis result information.

### Step 13

The terminal collects user input information and sends it to the server for emotion estimation.

Input: User voice, image, or text input captured at the terminal.

Output: Preprocessed user input features transmitted to the server.

The terminal captures audio via a microphone, images via a camera, or keystrokes via an input device. The terminal optionally performs local preprocessing, such as extracting audio features or down-sampling images, and packages the resulting data together with a user ID and session ID. The terminal transmits this user input information to the server for further analysis.

### Step 14

The server estimates the user's emotional state using an emotion estimation program and adjusts notification parameters.

Input: User input information features.

Output: Estimated emotional state and updated notification settings.

The server extracts prosodic features from audio, facial features from images, or sentiment features from text. The server supplies these features to an emotion classifier model that outputs probabilities for several emotional categories. The server selects a dominant category, such as “confused” or “calm,” and stores it as the current emotional state. Based on this state, the server adjusts notification parameters, such as priority flags, choice of presentation template, and required level of detail in explanations.

### Step 15

The server optionally regenerates or refines a prompt sentence for the generative AI model to tailor explanations to the estimated emotional state.

Input: Estimated emotional state and analysis result information.

Output: An adapted prompt sentence for explanation generation.

The server selects a modified prompt template when the emotional state indicates tension or confusion. For example, the server generates a prompt sentence such as:

“The user may be confused.

Explain the following inconsistency in very simple and clear language, and include specific recommended next steps.
Field: Clause A/Amount
Physical value: 1,000,000 JPY
Electronic value: 1,200,000 JPY.”

The server replaces or augments the previous prompt and sends the adapted prompt to the generative AI model to obtain an explanation appropriate for the user's state.

### Step 16

The server sends the analysis result information and the user-oriented explanation sentence to the terminal for presentation.

Input: Analysis result information and generated explanation sentences.

Output: Displayable data structures and presentation instructions.

The server formats the data into a response message that includes inconsistent fields, their values, consistency indices, and explanation text. The server chooses a presentation layout according to the notification parameters and transmits the response to the terminal.

### Step 17

The terminal displays the inconsistencies and explanations to the user and accepts user actions.

Input: Displayable data structures and presentation instructions from the server.

Output: Visual output on the display and user interaction events.

The terminal renders a user interface showing a list of fields, highlighting inconsistent ones, and presenting the generated explanation sentences near each item. The user inspects the information, selects items for detailed view, and may initiate correction actions or mark items as resolved. The terminal records user actions and, if necessary, sends updates back to the server, completing the processing flow for the document.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional document verification systems that compare electronic documents with documents recorded on physical media typically rely on rule-based text matching or manual human review. Such systems suffer from several technical shortcomings from a computer-technology standpoint.

First, known systems generally treat extracted document text as unstructured strings and perform simple keyword matching or position-based comparison. When documents differ in format, wording, or layout, these systems either fail to detect inconsistencies or generate numerous false positives. As a result, the computing resources of the server are consumed by inefficient matching operations, and additional human intervention is required to interpret ambiguous results, which limits scalability and throughput.

Second, even when machine learning techniques are used for document analysis, existing architectures usually operate in isolation: optical character recognition, natural language processing, and anomaly detection are executed as separate, loosely coupled components. These systems do not systematically integrate a generative AI model that can be explicitly guided by structured prompt sentences combining raw text, extracted fields, and discrepancy candidates. Consequently, the processing pipeline cannot fully leverage the reasoning capabilities of the generative AI model to refine discrepancy detection and explanation, and the overall accuracy and robustness of the automated comparison remain limited.

Third, conventional systems generally treat user interaction as static, independent of the user's cognitive or emotional state. Notification messages are generated with fixed templates and delivered immediately once discrepancies are detected, regardless of the user's current stress level or workload. This rigid behavior can cause information overload, increase user error rates when handling complex discrepancy reports, and reduce the practical effectiveness of the automated system. From a technical viewpoint, the server does not exploit available multimodal input (voice, image, text) to adapt its communication strategy, and therefore cannot optimize the timing, channel, or style of notifications to improve the human-computer interaction loop.

Fourth, logging and usage of generative AI models in existing workflows are often ad-hoc: prompt design, input selection, and output usage are not programmatically controlled as part of a coherent processing graph. This leads to non-deterministic behavior, difficulty in auditing decisions, and inefficient use of computing and network resources when repeatedly sending redundant content to the generative AI model.

Accordingly, there is a need for an improved computer-implemented system that (i) unifies OCR, natural language processing, structured data extraction, and machine learning-based evaluation into a single coordinated pipeline; (ii) programmatically generates and manages prompt sentences for a generative AI model based on both structured and unstructured document data; (iii) estimates a user's emotional state from multimodal signals and uses the estimated state to dynamically control when and how discrepancy information is presented; and (iv) thereby improves the efficiency, accuracy, and usability of document inconsistency detection at the level of the underlying computing architecture rather than merely automating a manual workflow.

The specific processing by the specific processing unit 290 of the data processing device 12 in Application Example 2 is realized by the following means.

The present invention provides a server comprising a processor configured to execute image analysis and optical character recognition to convert image data and electronic file data into character string information, apply natural language processing and statistical string analysis to convert the character string information into structured information including multiple information items, perform item-level collation between information items obtained from documents recorded on an electronic medium and information items obtained from documents recorded on a physical medium to determine match information, mismatch information, and missing information, compute importance evaluation information for the mismatch information and the missing information by using a machine-learning processing model, generate guidance information as a prompt sentence that includes at least the structured information and the mismatch information and that instructs a generative information processing model to analyze document contents, input the guidance information into the generative information processing model to obtain response information including a summary and explanation of inconsistencies, estimate an emotional state of a user by fusing results of voice information analysis, image information analysis, and textual emotional analysis applied to user signals, generate notification control information for dynamically determining timing, medium, and expression style of notification information based on the emotional state and the importance evaluation information, and transmit notification information including at least a portion of the response information to a user terminal in accordance with the notification control information. This enables the computing system to automatically detect and explain document inconsistencies with higher precision by combining structured comparison and guided generative analysis, to reduce unnecessary processing and user cognitive load through emotion-aware notification control, and to improve overall performance, robustness, and usability of computer-implemented document verification beyond the capabilities of conventional rule-based or static notification systems.

The term “electronic medium” refers to any non-transitory computer-readable storage or transmission medium on which document information is represented in digital form and is processable by an electronic information processing apparatus.

The term “physical medium” refers to any tangible substrate, such as paper or film, on which document information is recorded in a human-readable form and which requires imaging or scanning to be processed by an electronic information processing apparatus.

The term “document” refers to any collection of symbol sequences, including characters, numerals, and graphical marks, that record contractual, transactional, or approval-related information, regardless of whether the document is stored on an electronic medium or on a physical medium.

The term “information item” refers to a logically distinguishable unit of document content, such as monetary amount information, date and time information, subject information, condition information, or any other field extracted from a document for comparison or analysis.

The term “character string information” refers to a sequence of characters obtained from a document, including letters, numerals, punctuation marks, and symbols, which is suitable for processing by natural language processing and statistical analysis components.

The term “structured information” refers to data that has been organized into a predefined format, such as key-value pairs, tables, or records, in which each information item extracted from a document is associated with a specific field name or attribute for programmatic comparison.

The term “image data” refers to pixel-based digital data representing a captured view of at least part of a document, obtained by an imaging device or an image acquisition device, and including still images or sequences of images.

The term “electronic file data” refers to digital file data, such as text files, markup files, portable document files, or raster image files, that contain document information in a machine-readable format accessible by a computing system.

The term “image analysis processing” refers to a sequence of computational operations performed on image data, including but not limited to grayscale conversion, binarization, noise reduction, contrast enhancement, and geometric correction, for the purpose of improving subsequent character recognition or information extraction.

The term “optical character recognition processing” refers to a computational technique that analyzes image data containing printed or handwritten characters to identify the characters and output corresponding character string information.

The term “natural language processing” refers to a collection of computational methods and algorithms for analyzing and understanding human language text, including tokenization, part-of-speech tagging, syntactic parsing, semantic analysis, entity recognition, and relation extraction.

The term “statistical string analysis” refers to processing that applies statistical or probabilistic methods to character string information to detect patterns, segment text, normalize expressions, or compute similarity measures for use in extraction and comparison of information items.

The term “item-level collation” refers to a comparison procedure in which corresponding information items from different documents are aligned and evaluated individually to determine whether each item matches, mismatches, or is missing.

The term “match information” refers to comparison result data indicating that a particular information item extracted from one document corresponds in value or meaning to a corresponding information item extracted from another document.

The term “mismatch information” refers to comparison result data indicating that a particular information item extracted from one document differs in value or meaning from a corresponding information item extracted from another document.

The term “missing information” refers to comparison result data indicating that an information item present in one document does not have a corresponding information item present in another document.

The term “contract condition information” refers to one or more information items specifying terms of a contractual relationship, including but not limited to monetary amounts, dates, parties, obligations, rights, penalties, and performance conditions.

The term “transaction condition information” refers to one or more information items specifying terms of a commercial or financial transaction, including but not limited to prices, quantities, delivery conditions, payment conditions, and validity periods.

The term “machine learning processing model” refers to a mathematical model implemented in software and executed by a processor, which has been trained on example data to learn patterns, and which generates outputs such as classification scores, anomaly scores, or predictions when provided with input feature values.

The term “importance evaluation information” refers to data computed by the machine learning processing model or by rule-based logic that quantitatively or qualitatively represents a degree of significance, priority, or severity associated with specific mismatch information or missing information.

The term “generative information processing model” refers to a machine learning model, such as a generative language model, that is configured to generate new text or other output data based on input information, including prompt sentences, structured information, or document content.

The term “guidance information” refers to control data, including a prompt sentence and optionally additional structured context, that specifies to the generative information processing model what analysis to perform, what aspects of the input data to focus on, and what format or style the output should take.

The term “prompt sentence” refers to a natural language expression included in the guidance information and provided as input to the generative information processing model to instruct the model regarding a target task, such as discrepancy detection, explanation generation, or message drafting.

The term “response information” refers to output data produced by the generative information processing model in response to the guidance information, including any combination of summary information, detailed explanatory information, and correction proposal information.

The term “summary information” refers to a condensed representation of detected inconsistencies or other document analysis results, expressed in a reduced length or simplified form for easier comprehension.

The term “detailed explanatory information” refers to descriptive output that explains the nature, location, and potential impact of inconsistencies or other analysis results at a finer level of granularity than the summary information.

The term “correction proposal information” refers to output data that suggests modifications, clarifications, or confirmation actions for resolving detected inconsistencies or missing information in documents.

The term “explanatory message” refers to a message presented to a user that includes at least part of the response information from the generative information processing model and is intended to explain detected inconsistencies or recommended actions.

The term “voice information analysis” refers to processing performed on an acoustic signal representing a user's voice, including extraction of prosodic features, spectral features, and other parameters, for determining characteristics such as intensity, pitch variation, and speaking rate.

The term “image information analysis” refers to processing performed on image data representing at least a user's face or body, including detection of facial regions, extraction of facial features, and recognition of expressions that are indicative of emotional states.

The term “textual emotional analysis” refers to processing of character string information input by a user, including sentiment analysis, opinion mining, and emotion classification, to infer a probable emotional state from textual content.

The term “emotional state” refers to a classification of a user's psychological or affective condition, such as stressed, calm, frustrated, or relaxed, which is inferred from one or more of voice, image, and text inputs.

The term “state information” refers to data representing a result of emotional state estimation, including at least an identified emotional category and optionally a confidence value or intensity value.

The term “notification information” refers to data prepared for presentation to a user that includes at least mismatch information, missing information, or response information from the generative information processing model.

The term “notification control information” refers to data that determines or influences a timing, medium, order, and expression style of presentation of notification information, and that is generated based on at least the state information and the importance evaluation information.

The term “presentation timing” refers to a temporal parameter specifying when notification information should be delivered or displayed to a user, such as immediately, after a delay, or in a scheduled batch.

The term “presentation medium” refers to a communication channel or interface through which notification information is provided to a user, including but not limited to an in-application message, a pop-up window, an email message, or a push notification.

The term “presentation expression” refers to a linguistic or graphical style used to present notification information, including the tone, level of formality, amount of detail, and formatting of the explanatory message.

The term “user terminal device” refers to any electronic apparatus operated by a user, such as a mobile terminal, a personal computer, or a dedicated terminal, which is configured to communicate with the server, send document data and user signals, and display notification information.

In one embodiment, a server and one or more terminals cooperate to implement the claimed system.

The server executes a program on one or more processors, such as central processing units and optional graphics processing units.

The terminal operates as a user-facing device that captures document data and user signals and displays notification information.

The server stores and executes a document-analysis program and an emotion-estimation program on an operating system, such as a general-purpose server operating system.

The server further runs middleware components including a web application framework, a message queue, and a relational or non-relational database system.

The server uses concrete software libraries for image analysis and optical character recognition, such as an image processing library (for example, an implementation equivalent to OpenCV) and an OCR engine (for example, an implementation equivalent to Tesseract).

The server uses concrete software libraries for natural language processing and statistical string analysis, such as tokenizers, part-of-speech taggers, and named-entity recognizers (for example, implementations equivalent to spaCy, NLTK, and Apache OpenNLP).

The server uses machine learning frameworks, such as a tensor-computation framework (for example, an implementation equivalent to TensorFlow) or a deep-learning framework (for example, an implementation equivalent to PyTorch), to implement a machine learning processing model and a generative AI model interface.

The server also uses emotion-analysis components, such as facial-expression classifiers based on a vision library (for example, an implementation functionally similar to DeepFace or a commercial emotion-recognition SDK), speech-feature extractors (for example, a speech-to-text and prosody-analysis pipeline), and text sentiment analyzers.

The terminal includes at least one imaging device, such as a camera module, at least one acoustic sensor, such as a microphone, a display device, and a network interface.

The terminal runs a client application that connects to the server over a packet-based network via secure transport protocols.

The client application can be implemented as a mobile application, a desktop application, or a web application running within a browser.

The server stores document data in a document repository.

The server stores each uploaded electronic file or image in a storage system and associates it with metadata, such as a document identifier, a user identifier, and a document type flag (for example, electronic contract, scanned contract, approval form).

The server maintains a structured-data store where extracted information items are represented in a normalized form.

Each structured record includes fields such as a document identifier, a document type, a party field, a monetary amount field, multiple date fields, and one or more textual clause descriptors.

The server further maintains a discrepancy store where item-level comparison results are stored as records containing a document-pair identifier, a field name, values from each document, and severity values.

The server configures the machine learning processing model as a neural network trained to map input feature vectors to an importance score.

The server constructs each input feature vector by concatenating numerical encodings of information items and comparison features.

For example, the server encodes a monetary amount as a normalized scalar, encodes a date difference as a number of days, encodes a field type as a one-hot vector, and encodes a categorical contract type as an embedding vector.

The server then feeds these feature vectors into a feed-forward neural network with multiple fully connected layers, each layer including weight matrices and non-linear activation functions such as rectified linear units.

The server trains the neural network by minimizing a loss function, such as a mean-squared error between predicted importance scores and target labels, or a cross-entropy loss for discrete severity classes.

The server updates network weights using a gradient-based optimization algorithm, such as stochastic gradient descent with momentum or an adaptive learning-rate optimizer.

The server may apply regularization techniques, such as dropout or L2-norm penalties, and data-augmentation techniques, such as synthetic perturbation of amounts and dates within permitted ranges, to improve generalization.

By structuring the model in this manner, the server can infer a continuous or discrete importance evaluation for each mismatch or missing information, which directly influences subsequent notification control.

The server configures the generative AI model as a large-scale neural language model hosted locally or accessed through an external inference service.

The generative AI model is a deep neural network that maps a sequence of input tokens to a sequence of output tokens, where each token corresponds to a sub-word or character.

The model includes an embedding layer that maps tokens into dense vectors, multiple attention-based layers or recurrent layers that capture contextual dependencies, and an output layer that produces probability distributions over the vocabulary.

The server does not depend on an abstract “intelligent” behavior but instead uses deterministic prompt sentences and deterministic decoding parameters (for example, low temperature and restricted maximum output length) to obtain reproducible and auditable outputs.

The server defines specific fields in the guidance information, including a task descriptor, a schema description, and one or more text segments to be compared.

By feeding both structured comparison results and original text snippets into the generative AI model with carefully constructed prompt sentences, the server obtains outputs that are aligned with the item-level collation and importance evaluation.

The server configures the emotion-estimation program as a modular pipeline.

For voice information analysis, the server receives digitized audio frames from the terminal and extracts acoustic features, such as Mel-frequency cepstral coefficients, pitch contours, energy envelopes, and speaking rate measures.

The server passes these features into a classifier network, such as a convolutional or recurrent neural network trained on labeled emotional speech data, to obtain probabilities for emotional categories.

For image information analysis, the server uses a vision library to detect face regions in video frames, normalizes the detected faces, and extracts feature vectors based on facial landmarks and convolutional feature maps.

The server passes these vectors into a trained classifier that outputs scores for expressions such as happiness, neutrality, anger, or sadness.

For textual emotional analysis, the server tokenizes user text input and embeds tokens into vectors, then uses a sequence classification model to predict sentiment or emotion labels.

The server then combines these modality-specific scores through a fusion network or weighted averaging logic to produce final state information representing the user's emotional state.

The server generates guidance information for the generative AI model by concatenating fixed instruction segments and variable data segments.

In one example, the server generates a prompt sentence for basic document discrepancy detection as: “Analyze the following two documents. The first is an electronic contract, and the second is a scanned paper contract converted to text. Extract the main terms (parties, total amount, currency, key dates, and payment conditions) from each document and list any discrepancies between them.

Provide your answer as a JSON object with fields: ‘amount_discrepancy’, ‘date_discrepancy’, ‘party_discrepancy’, and ‘other_issues’. Document A (electronic contract): [text of electronic contract] Document B (paper contract): [text of paper contract].”

In another example, the server generates a prompt sentence that explicitly considers the user's emotional state and desired tone of output as:

“Generate a short notification message about the following contract discrepancies. If the emotion is ‘stressed’, use a calm and reassuring tone and mention only the top one or two critical issues. If the emotion is ‘relaxed’, list all discrepancies with clear next steps. Input: emotion=[current emotion], discrepancies=[list of discrepancies].”

In another example, the server generates a prompt sentence for cross-checking a single new contract against a reference record as:

“Analyze the following new contract text. Extract the contract amount, start date, end date, and main obligations. Then compare these values with the reference record below. Indicate whether each field matches or mismatches and describe any differences. New contract text: [contract text]. Reference record: amount [value], start date [value], end date [value].”

By reusing such structured prompt sentences, the server ensures that the generative AI model receives consistent instructions, which minimizes ambiguity and facilitates stable behavior.

The server improves computer-technology performance in several ways.

The server first performs deterministic OCR and NLP extraction to obtain structured information.

The server then runs a dedicated, relatively small machine learning processing model to filter and prioritize discrepancies before invoking the generative AI model.

By doing this, the server reduces the amount of data and complexity sent to the generative AI model, which significantly lowers computation time and network bandwidth consumption compared to directly sending entire documents for unconstrained analysis.

The server further caches and indexes structured representations so that repeated comparisons can be performed on numerical vectors instead of full text, which improves processing throughput and memory locality.

The architecture is therefore not a mere automation of human reading but a re-engineering of data structures and execution order to better exploit computing resources.

The server also improves accuracy of inconsistency detection beyond simple rules.

The server's item-level collation uses both exact matching and normalized comparison, including numerical tolerances for amounts and fuzzy similarity for textual items, which lowers false mismatches due to trivial formatting differences.

The machine learning processing model incorporates patterns learned from past accepted and rejected discrepancies, allowing the server to discriminate between practically important inconsistencies and benign variations.

The generative AI model, controlled by precise prompt sentences, refines these results by recognizing semantic differences that may not be captured by numeric thresholds, such as subtle changes in payment conditions or liability clauses.

This layered design, combining rule-based collation, statistical learning, and generative explanation, yields higher detection precision and reduces error rates in automated processing.

The server changes how notification information is managed internally.

Instead of emitting notifications whenever discrepancies are detected, the server computes notification control information that includes a scheduled time, a selected communication channel, and a target level of detail.

The emotion state is a technical input to this control logic: for example, high stress levels cause the server to defer low-importance notifications and to compress messages, whereas relaxed states allow the server to send more detailed and frequent messages.

This behavior is realized by concrete scheduling algorithms and message-formatting routines, not by abstract “judgment.”

The effect is a reduction in ineffective network transmissions and user-interface clutter, which improves the responsiveness and stability of the overall system.

The terminal transmits document images and files in a format optimized for the server's pipeline.

The terminal may perform pre-compression of images at a configured resolution and quality level that balances legibility and bandwidth usage.

The terminal may annotate uploaded data with simple metadata, such as orientation hints or document type selections, which reduces the amount of heuristic processing required by the server.

The terminal also acts as a sensor platform for emotion-related signals.

For example, the terminal captures a short audio sample from the microphone at predetermined intervals only when certain user actions are detected, thereby limiting redundant data transfer.

The terminal captures face images under specific lighting conditions using built-in camera controls to stabilize face detection and expression classification.

These optimizations reduce communication overhead and increase reliability of downstream emotion estimation.

The user interacts with the system through the terminal's display and input controls.

The user selects documents to be uploaded, optionally labels them, and initiates analysis.

The user receives notifications that include explanations generated partly by the generative AI model.

The user can confirm or dismiss discrepancies or request additional detail through interface elements.

These actions are recorded by the server to further refine the machine learning processing model through incremental retraining, if desired.

In an alternative embodiment, the server may execute the generative AI model locally without relying on an external service.

In this case, the server stores parameter matrices of a transformer-based language model in non-volatile memory and loads them into main memory for inference.

The server executes matrix-multiplication kernels on graphics processing units or specialized accelerators.

The same guidance-information structure and prompt sentences are used, but the data does not leave the server's trusted environment, which may improve privacy and reduce latency.

In another embodiment, the server may implement the generative AI functionality by a rule-augmented decoder.

The server first uses a deterministic algorithm to generate candidate discrepancy descriptions from structured information and then uses a smaller neural network to refine wording and tone based on emotion state and user preferences.

This configuration can be used in resource-constrained deployments while still following the same high-level architecture of guidance information, response information, and notification control information.

In yet another embodiment, the server may adjust the internal architecture of the machine learning processing model.

For example, the server may provide a multi-task network where one branch predicts importance scores and another branch predicts recommended notification channels.

By sharing early layers between tasks, the model can reuse representations of contract fields and discrepancies, improving computational efficiency and predictive performance.

Through these implementations and variations, the server, the terminal, and the user cooperate in a system that transforms raw document images and heterogeneous user signals into structured, prioritized, and emotion-aware discrepancy information.

The described data structures, neural-network configurations, prompt-sentence schemes, and control logic provide concrete improvements in computational efficiency, detection accuracy, and communication behavior of the underlying computer system, rather than merely automating existing manual document review practices.

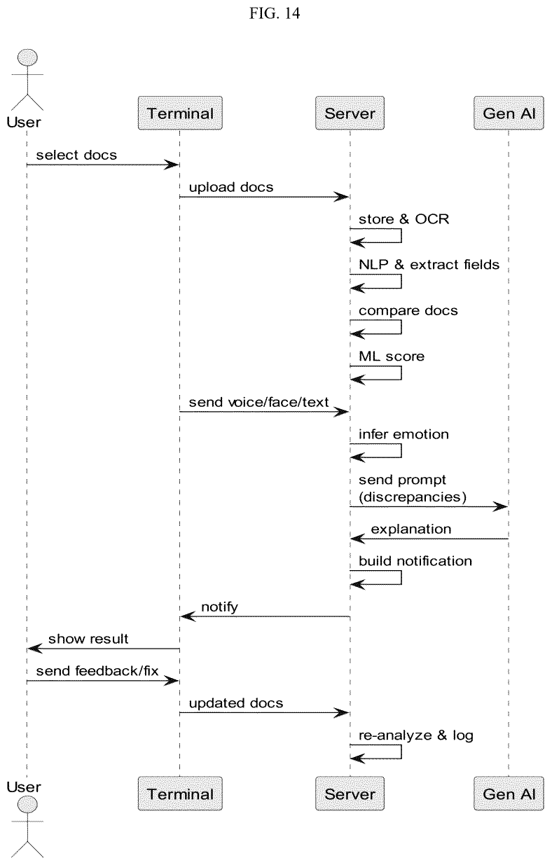

The following describes the processing flow using FIG. 14.

### Step 1

The user prepares target documents.

The user collects electronic contracts, scanned contracts, approval forms, and other transaction-related documents that must be checked for consistency.

Input: physical documents and existing electronic document files.

Output: a set of documents selected by the user as targets for analysis.

### Step 2

The terminal acquires document data.

The terminal uses an imaging device to capture high-resolution images of physical documents, encodes the images as raster files, and uses file system APIs to select existing electronic files such as PDF or image files.

Input: physical documents placed in front of the camera and electronic files stored on the terminal or in a remote storage service.

Data processing: the terminal converts optical information from the camera into digital image data, applies optional local compression, and reads file bytes from storage.

Output: digital image data and electronic file data stored temporarily in the terminal.

### Step 3

The terminal transmits document data and metadata to the server.

The terminal establishes a secure network connection to the server and sends the digital image data and electronic file data together with metadata such as user identifier, document type, and capture timestamp.

Input: digital image data, electronic file data, and user-provided metadata.

Data processing: the terminal packages the data in a request body, encodes metadata as structured fields, and performs error checking before transmission.

Output: an upload request containing document data and metadata delivered to the server.

The server stores raw document data and registers document records.

The server receives the upload request, writes the digital image data and electronic file data into a storage subsystem, and creates document records in a document database with references to stored file locations and metadata.

Input: uploaded document data and metadata from the terminal.

Data processing: the server assigns unique document identifiers, normalizes metadata (for example, normalizing document type codes), and persists file paths and identifiers in persistent storage.

Output: registered document records linked to stored raw document files.

### Step 5

The server performs image preprocessing for optical character recognition.

The server reads each stored image associated with a document, converts it to grayscale, applies thresholding, de-skews rotated pages, reduces noise, and enhances contrast in preparation for character recognition.

Input: raw image data associated with a document record.

Data processing: the server applies image-processing algorithms to transform each pixel matrix into a cleaned and normalized form that increases recognition accuracy for small fonts, stamps, and signatures.

Output: preprocessed image data ready for optical character recognition.

### Step 6

The server performs optical character recognition and text extraction.

The server applies an optical character recognition engine to the preprocessed image data and, for electronic file data such as PDFs, extracts embedded text or renders pages to images and then applies the optical character recognition engine.

Input: preprocessed image data and electronic file data associated with each document.

Data processing: the server segments text regions, identifies character shapes, maps them to character codes, and concatenates the results into linear text strings.

Output: raw character string information representing the textual content of each document.

### Step 7

The server normalizes and aggregates textual content.

The server aggregates page-level character strings belonging to the same document, converts character encodings if needed, normalizes spacing and line breaks, and removes obvious repeated headers and footers.

Input: page-level character string information for each document.

Data processing: the server concatenates strings, performs character normalization (for example, converting full-width and half-width forms), and applies pattern filters to remove boilerplate layout artifacts.

Output: a canonical document-level text string for each document.

### Step 8

The server performs natural language processing and tokenization.

The server uses natural language processing components to segment the document text into sentences and tokens, performs part-of-speech tagging, and detects named entities such as organizations, persons, dates, and monetary values.

Input: canonical document-level text string for each document.

Data processing: the server runs tokenization algorithms, linguistic taggers, and entity-recognition models to assign grammatical roles and semantic labels to segments of text.

Output: annotated text structures containing tokens, tags, and labeled entity spans.

### Step 9

The server extracts information items and constructs structured records.

The server analyzes the annotated text and applies extraction rules and statistical models to identify specific information items such as contract parties, amounts, currencies, effective dates, expiration dates, and key conditions.

Input: annotated text structures resulting from natural language processing.

Data processing: the server applies pattern matching, windowed context analysis, and numerical parsers to convert textual expressions into normalized field values and then assembles these values into structured records.

Output: structured information records for each document, with fields representing information items in a normalized format.

### Step 10

The server groups documents for comparison.

The server queries the structured information records and document metadata to identify documents that are related, such as an electronic contract, a scanned contract, and an approval form belonging to the same transaction.

Input: structured information records and document metadata stored in the database.

Data processing: the server applies grouping logic based on keys such as contract identifiers, customer identifiers, or matching party names to form document groups to be compared.

Output: sets of document groups, each containing at least two related documents for item-level comparison.

### Step 11

The server performs item-level collation between documents.

The server compares corresponding information items across documents in each group, including monetary amounts, date fields, party identifiers, and condition descriptors, and determines for each item whether the values match, mismatch, or are missing.

Input: structured information records for documents within each group.

Data processing: the server aligns fields by their semantic type, computes numeric differences for quantitative fields, applies string-similarity measures for textual fields, and uses thresholds to classify each pair as a match, mismatch, or missing item.

Output: item-level comparison results describing match information, mismatch information, and missing information for each document group.

### Step 12

The server encodes comparison features and evaluates importance with a machine learning model.

The server generates feature vectors for each mismatch or missing item by encoding quantities such as magnitude of numeric difference, degree of string similarity, field type, and contract type, then passes these vectors into a trained neural network model that outputs importance scores or severity classes.

Input: item-level comparison results and structured information records.

Data processing: the server maps each comparison into a numerical feature vector, runs the feature vector through matrix multiplications and non-linear activations in the neural network, and interprets the model output as importance evaluation information.

Output: enriched discrepancy records containing mismatch information or missing information with attached importance evaluation information.

### Step 13

The server prepares guidance information and a prompt sentence for a generative AI model.

The server assembles guidance information that includes a task description, examples of desired output format, segments of original document text, and the structured discrepancy records, and then formats these elements into a coherent prompt sentence in natural language.

Input: structured discrepancy records, original document text snippets, and predefined instruction templates.

Data processing: the server concatenates instruction segments, inserts variable values representing extracted fields and discrepancies, and constructs a syntactically consistent prompt instructing the generative AI model how to analyze the content.

Output: a prompt sentence and associated guidance information ready to be sent to the generative AI model.

### Step 14

The server obtains refined discrepancy explanations from the generative AI model.

The server sends the prompt sentence and the relevant content to the generative AI model, receives generated text that explains and summarizes inconsistencies, and parses the output to separate summary portions, detailed descriptions, and suggested corrections.

Input: prompt sentence and guidance information including document text and structured discrepancy data.

Data processing: the server encodes the prompt and content for the generative AI model interface, transmits the data, receives generated token sequences, and segments the generated text according to cues such as headings or list markers.

Output: response information from the generative AI model, including summarized inconsistencies, detailed explanatory text, and possible correction proposals.

### Step 15

The terminal acquires user emotion-related signals.

The terminal records short audio segments through its microphone, captures facial images or video frames through its camera, and collects text entered by the user through input fields during interaction with the system.

Input: physical voice signals, facial expressions, and typed text produced by the user.

Data processing: the terminal digitizes audio and video signals, encodes them into data formats supported by the server, associates them with session identifiers, and sends them to the server.

Output: audio data, image data, and text data representing user emotion-related signals transmitted to the server.

### Step 16

The server estimates the emotional state of the user.

The server processes audio data to extract speech features, processes facial images to extract facial landmarks and expression features, processes user text to compute sentiment scores, and then fuses these modality-specific results into a single emotional state classification.

Input: audio data, image data, and text data transmitted from the terminal.

Data processing: the server computes low-level features, feeds them into separate neural classifiers for each modality, aggregates classifier outputs using a fusion algorithm, and finally determines a predominant emotional category and a confidence score to form state information.

Output: state information describing the user's estimated emotional state.

### Step 17

The server generates notification control information based on importance and emotion.

The server examines the importance evaluation information attached to each discrepancy and the current emotional state of the user, and decides for each discrepancy how urgently it should be notified, which communication channel to use, and what level of detail to include.

Input: enriched discrepancy records and state information describing the user's emotional state.

Data processing: the server applies control rules or a decision model that maps combinations of severity and emotional state to notification parameters such as scheduling delay, medium selection, and detail level, and composes notification control information.

Output: notification control information specifying timing, medium, and expression preferences for upcoming notifications.

### Step 18

The server generates emotion-aware notification messages.

The server constructs notification content by combining the mismatch information, the importance evaluation information, and selected portions of the generative AI model's response, and adjusts wording and detail to match the notification control information, optionally using additional prompt sentences to refine message tone.

Input: enriched discrepancy records, response information from the generative AI model, and notification control information.

Data processing: the server selects which discrepancies to mention, formats descriptions based on severity, and, if required, prepares a secondary prompt sentence instructing the generative AI model to rewrite explanations in a specific tone or brevity level, and then integrates the resulting text into the final notification.

Output: notification messages ready to be delivered to the user through the terminal.

### Step 19

The server transmits notifications to the terminal.

The server sends the generated notification messages to the terminal using the medium indicated by the notification control information, such as in-app messages, push notifications, or email-like messages.

Input: notification messages and notification control information specifying destination and channel.

Data processing: the server formats the messages for the selected protocol, addresses them to the correct user and device, and schedules or dispatches them according to the specified timing.

Output: delivered notification payloads received by the terminal.

### Step 20

The terminal displays notification information and detailed discrepancy views.

The terminal receives the notification payloads, presents summary information in a concise view, and, upon user interaction, requests and displays detailed comparison results and explanatory text for specific discrepancies.

Input: notification payloads and, when requested, additional detail data retrieved from the server.

Data processing: the terminal renders the messages on the display, highlights mismatched fields, and organizes information in panels or sections allowing the user to compare electronic and physical document values side by side.

Output: a visual user interface showing discrepancy summaries and details to the user.

### Step 21

The user reviews discrepancies and performs corrective actions.

The user inspects the notification information, compares displayed document values, and decides whether to correct a document, accept a discrepancy, or provide feedback.

Input: displayed discrepancy details and explanatory messages from the terminal.

Data processing: the user interprets the information and operates user-interface controls to confirm, reject, or correct specific content, or to upload new document versions.

Output: user commands and updated or additional document data sent back to the server.

### Step 22

The server updates records and, if necessary, re-analyzes documents.

The server receives user commands and updated documents, modifies discrepancy records to reflect accepted or resolved items, and, when a document has been corrected or replaced, re-executes the extraction, collation, and evaluation steps for that document group.

Input: user commands, corrected documents, and existing discrepancy records.

Data processing: the server updates database entries, clears obsolete discrepancies, recomputes structured information and comparison results for changed documents, and may generate new prompt sentences for the generative AI model if new or remaining inconsistencies are found.

Output: updated structured information, updated discrepancy records, and, if needed, new or revised notification information.

### Step 23

The server logs processing history for audit and improvement.

The server records details of each processing stage, including prompt sentences sent to the generative AI model, responses received, comparison outcomes, emotional state estimates, and notification decisions, and stores this information for later audit or model retraining.

Input: intermediate and final data produced during document analysis, emotion estimation, and notification control.

Data processing: the server structures log records with timestamps, identifiers, and summaries of key events, compresses and indexes the logs, and persists them in an audit store.

Output: an auditable history of system behavior that can be used to verify operations and refine machine learning components.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

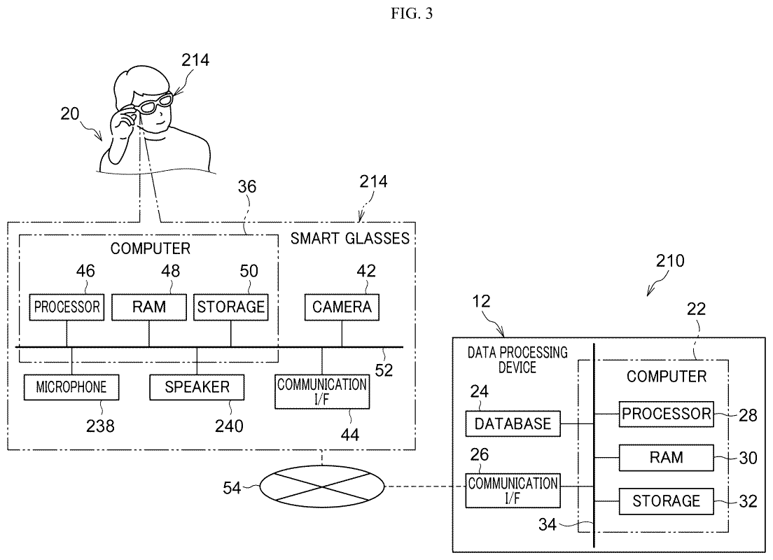

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

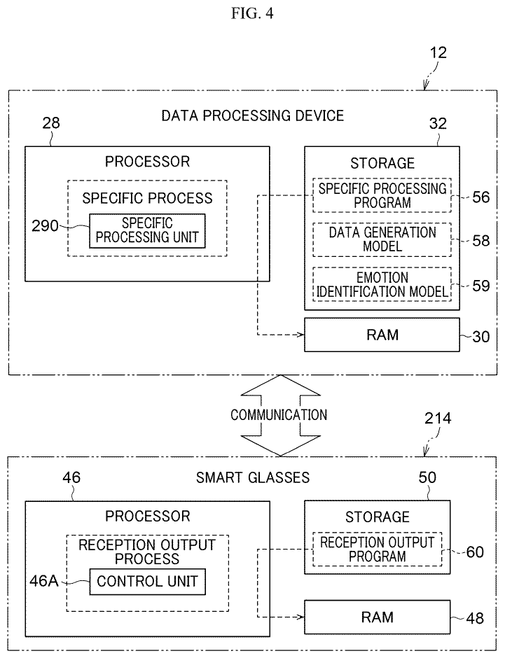

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

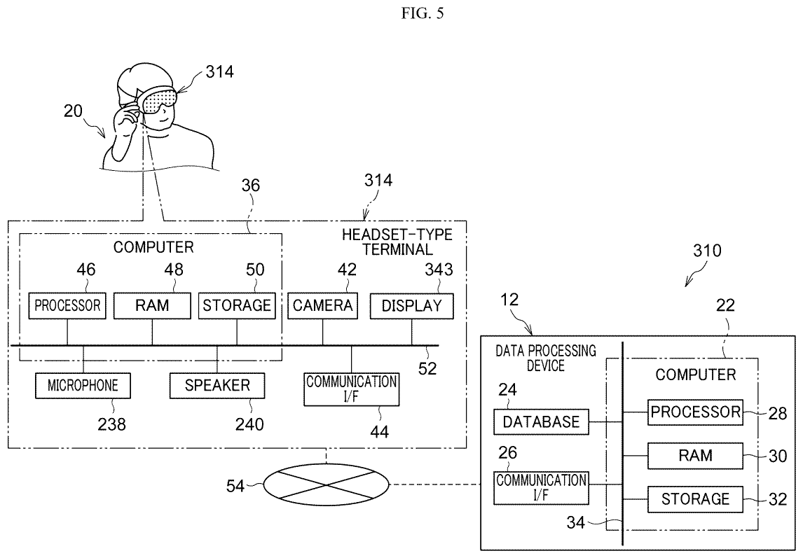

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

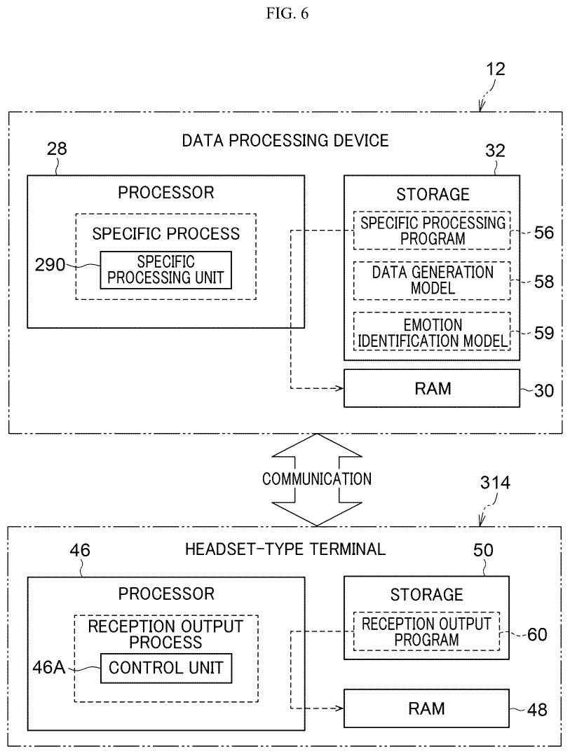

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

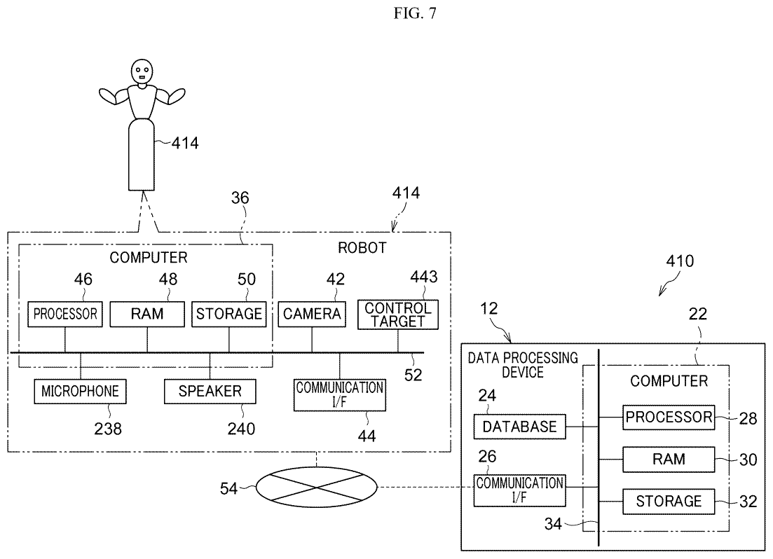

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

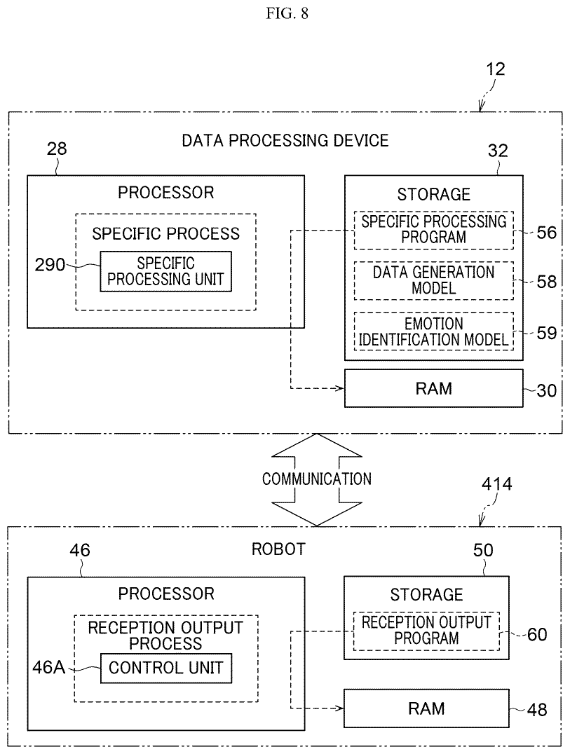

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

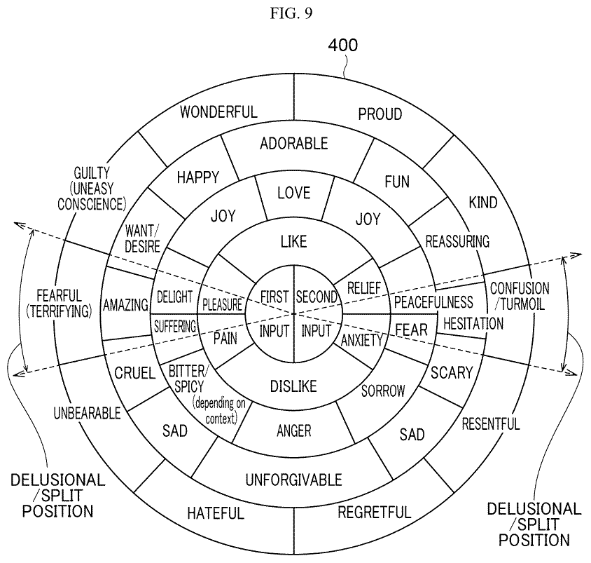

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

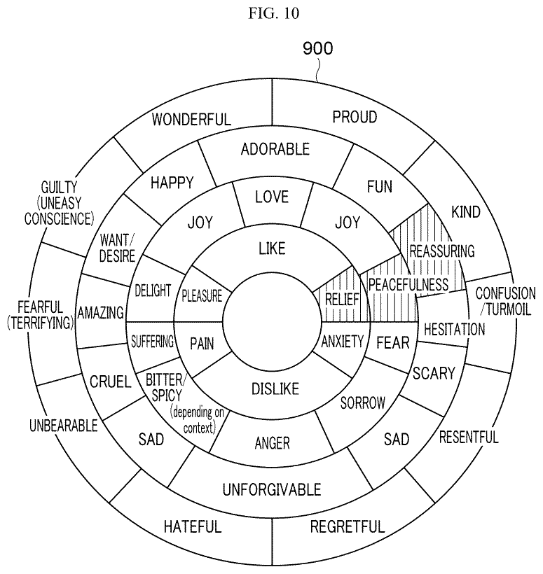

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from an input device or a communication network, an information group including electronic information, information recorded on a physical medium, and information attached to an approval procedure, and to execute an optical character recognition process on the information group to generate first information including character information,
analyze the first information by executing natural language processing and information extraction to generate structured information including clause information, numerical information, date information, and subject information,
align, on the basis of the structured information, a plurality of information units corresponding to one another among the electronic information, the information recorded on the physical medium, and the information attached to the approval procedure, and generate, for each of the information units, at least one comparison-target information pair,
input the comparison-target information pair to a determination model learned on the basis of machine learning, and generate, for each comparison-target information pair, determination information indicating presence or absence of a content inconsistency and a reliability of the determination,
classify, on the basis of the determination information, information units for which a content inconsistency is detected, information units for which a content inconsistency is not detected, and information units for which a determination is not possible, and generate, in accordance with a classification result, importance information and notification-priority information for each case, construct a prompt sentence as an input text for generation of explanation information in natural language from comparison-result information including the structured information and the determination information, input the prompt sentence and the comparison-result information to a generative AI model, and cause the generative AI model to generate explanation information including a summary of the content inconsistency and an explanation of an impact thereof, generate, on the basis of the explanation information and the importance information, display information or transmission information for a user, and output the display information or the transmission information so as to visually emphasize a location and a content of the content inconsistency, and
acquire, from the user, evaluation information regarding the explanation information and validity information regarding the determination information, and store the evaluation information and the validity information as history information usable for performance evaluation and updating of the determination model.

### Supplementary 2

The system according to supplementary 1,
wherein the processor is configured to
acquire, from the user, a prompt sentence for requesting an additional explanation or a summary from a specific viewpoint with respect to a determination result of the content inconsistency or the comparison-result information, generate input information by combining the prompt sentence with the comparison-result information, and input the input information to the generative AI model to generate additional explanation information according to a request content of the user.

### Supplementary 3

The system according to supplementary 1,
wherein the processor is configured to
calculate, on the basis of a type and a number of content inconsistencies per information unit in the determination result and the reliability, an evaluation index for each case, and dynamically change, in accordance with the evaluation index, at least one of a configuration, an emphasis degree, and a presentation order of the explanation information and the display information.

### Application Example 1

### Supplementary 1

A system comprising a processor,
wherein the processor is configured to
perform a character recognition process on document image data acquired by an image acquisition device to extract character information, in order to automatically determine inconsistencies of information between electronic contract information, the document image data of a paper-based document, and attachment document data related to an approval procedure,
perform an information analysis process on the electronic contract information and the extracted character information, the information analysis process including natural language processing and text information extraction processing to structure contents on a sentence unit or an item unit basis, and to determine presence or absence of required items and consistency or inconsistency of values based on predetermined item definitions or template information,
generate a prompt sentence for analyzing and comparing document contents by using a generative AI model, the prompt sentence being generated based on comparison target information including the extracted character information, the electronic contract information, and a determination result of the information analysis process, and input the generated prompt sentence into the generative AI model to cause the generative AI model to generate natural language output information including explanation information or correction instruction information regarding the inconsistencies of the information,
generate inconsistency information including presence or absence of the inconsistencies of the information, locations of the inconsistencies, types of the inconsistencies, and importance levels, based on the information analysis process and the natural language output information generated by the generative AI model, and transmit the inconsistency information and the natural language output information as notification information to a terminal device, and
execute emotion estimation processing to estimate an emotional state of a user from at least one of voice information, image information, and character input information of the user, and change a presentation mode or a priority of the notification information in accordance with the emotional state.

### Supplementary 2

The system according to supplementary 1,
wherein the processor is configured to
execute, in the information analysis process, natural language processing on the electronic contract information and the extracted character information, the natural language processing including word segmentation processing, syntactic analysis processing, semantic analysis processing, and named entity recognition processing, to extract information units representing at least one of a party name, an amount, a date, a period, a condition, and a clause heading, and to determine the inconsistencies of the information for each of the information units.

### Supplementary 3

The system according to supplementary 1,
wherein the processor is configured to
execute, in the emotion estimation processing, at least one of voice feature extraction processing, facial expression feature extraction processing, and writing style feature extraction processing to classify the emotional state of the user, and dynamically change at least one of a presentation timing, a presentation medium, and a level of detail of the notification information based on a classification result of the emotional state.

### Example 2

### Supplementary 1

A system comprising a processor,
wherein the processor is configured to
acquire image information representing information recorded on a physical medium by using an image acquisition device, and transmit the acquired image information to a terminal apparatus,
control the terminal apparatus to execute a character recognition program on the image information so as to extract character information and to transmit the extracted character information to a server apparatus,
obtain, in the server apparatus, the character information and electronic information stored in a storage device, and analyze the character information and the electronic information on a phrase unit or sentence unit basis by using a natural language processing program so as to extract key information including clause information, numerical information, date information, and party information,
generate, in the server apparatus, comparison items based on an association rule between the key information and the electronic information, and generate structured data by associating, for each comparison item, a value derived from the physical medium with a value derived from the electronic information,
input, in the server apparatus, the structured data to a trained determination model constructed by using a machine learning program, and output, for each comparison item, a consistency index and a content inconsistency determination result so as to automatically determine a content inconsistency between information derived from the physical medium and the electronic information,
generate, in the server apparatus, analysis result information including content inconsistency items, a value on a physical medium side, a value on an electronic information side, and the consistency index, based on comparison result data including the content inconsistency determination result, and transmit the analysis result information to a user terminal,
generate, in the server apparatus, a prompt sentence for using a generative artificial intelligence model, the prompt sentence being for generating a natural language explanation sentence that explains details of the content inconsistency and a recommended response method, and input the prompt sentence and the analysis result information to the generative artificial intelligence model so as to generate a user-oriented explanation sentence, and
analyze, in the server apparatus, voice information, image information, or character input information of a user by using an emotion estimation program to estimate an emotional state of the user, and change a priority, a presentation format, or expression content of a notification regarding the content inconsistency in accordance with the estimated emotional state,
wherein the processor is further configured to cause the system to perform the above operations.

### Supplementary 2

The system according to supplementary 1,
wherein the processor is configured to
include, in the prompt sentence to be input to the generative artificial intelligence model, structured data including at least a name of each comparison item, the value derived from the physical medium, the value derived from the electronic information, the content inconsistency determination result by the trained determination model, and the consistency index, and instruct the generative artificial intelligence model to generate a summary of the content inconsistency and the user-oriented explanation sentence.

### Supplementary 3

The system according to supplementary 1,
wherein the processor is configured to
when the emotional state of the user estimated by the emotion estimation program indicates a state of tension, confusion, or anxiety, add, to the prompt sentence for the generative artificial intelligence model, an instruction to include plain explanations and recommended actions for supporting understanding of the user, and change at least one of a style, a length, and a level of detail of the user-oriented explanation sentence.

### Application Example 2

### Supplementary 1

A system comprising a processor,
wherein the processor is configured to
generate guidance information for instructing a generative information processing model to analyze contents of documents, in order to automatically determine inconsistency of information contents between documents recorded on an electronic medium and documents recorded on a physical medium,
generate, as a prompt sentence to be input to the generative information processing model, a natural language expression including character information acquired from a plurality of kinds of documents and information items to be compared between the documents,
extract character string information from image data and electronic file data by using information analysis processing including image analysis processing and optical character recognition processing, the image data being acquired by an imaging device or an image acquisition device,
convert the extracted character string information into structured information by using natural language processing and statistical character string analysis, and extract a plurality of information items including monetary amount information, date and time information, subject information, and condition information,
perform, based on the structured information, item-level collation processing between information items obtained from a document recorded on the electronic medium and information items obtained from a document recorded on the physical medium, and determine, for each information item, match information, mismatch information, or missing information,
calculate, by using a machine learning processing model, importance evaluation information for the mismatch information and the missing information obtained by the collation processing, and determine severity of inconsistency related to contract condition information or transaction condition information,
estimate an emotional state of a user by using emotional state estimation processing including voice information analysis, image information analysis, and textual emotional analysis applied to an acoustic signal, a facial image signal, or input character string information of the user, and generate state information indicating the emotional state,
generate notification control information for dynamically determining a presentation timing, a presentation medium, and a presentation expression of notification information related to the mismatch information or the missing information, based on the state information and the importance evaluation information,
transmit, to a user terminal device, the notification information including the mismatch information or the missing information in accordance with the notification control information, and
generate guidance information for generating an explanatory message to be presented to the user based on information including the mismatch information and the importance evaluation information, and input the guidance information to the generative information processing model to cause the explanatory message to be generated.

### Supplementary 2

The system according to supplementary 1,
wherein the processor is configured to operate the generative information processing model by using, as input, at least the guidance information, the structured information, and the mismatch information, obtain response information including summary information of the inconsistency of information contents between the documents, detailed explanatory information, and correction proposal information, and present at least a part of the response information as the notification information to the user terminal device.

### Supplementary 3

The system according to supplementary 1,
wherein the processor is configured to change, in accordance with the emotional state estimated by the emotional state estimation processing, a description content, an information amount, and an expression style of the guidance information to be input to the generative information processing model, and dynamically adjust a writing style, a detail level, and selection of target mismatch information of the explanatory message.

What is claimed is:

1. A system comprising:
circuitry configured to:
acquire, via a communication interface coupled to a packet-switched network, an information group comprising electronic information, information derived from a physical medium, and information associated with an approval procedure, and execute optical character recognition on at least a portion of the information group to generate first data comprising character information;
analyze the first data by executing natural language processing and information extraction to generate structured data comprising clause information, numerical information, date information, and subject information;
align, based on the structured data, a plurality of information units corresponding to one another among the electronic information, the information derived from the physical medium, and the information associated with the approval procedure, and generate, for each information unit, at least one comparison-target pair;
input each comparison-target pair to a determination model trained by machine learning and generate, for each comparison-target pair, determination data indicating presence or absence of a content inconsistency and a reliability value;
classify, based on the determination data, information units into inconsistency-detected, inconsistency-not-detected, and determination-not-possible categories, and generate importance data and notification-priority data for each information unit based on the classification;
construct a prompt data structure comprising the structured data and the determination data, and transmit the prompt data structure to a generative neural network model to cause the generative neural network model to generate explanation data comprising a summary of each content inconsistency and an impact description;
generate, based on the explanation data and the importance data, display data or transmission data for a terminal device that visually emphasizes a location and content of each content inconsistency; and
acquire evaluation data from the terminal device regarding the explanation data and validity data regarding the determination data, and store the evaluation data and the validity data as history data for updating the determination model.

2. The system according to claim 1,
wherein the circuitry generates the prompt data structure by embedding the structured data as key-value pairs and the determination data as classification labels with associated reliability values, and includes in the prompt data structure an instruction that constrains the generative neural network model to reference only data present in the structured data when generating the explanation data.

3. The system according to claim 2,
wherein the circuitry is further configured to perform the information extraction using at least morphological analysis, named entity recognition, and numerical pattern extraction on the first data, and generate the structured data as a tabular representation with rows corresponding to individual information items and columns corresponding to source type, extracted value, and item category.

4. The system according to claim 1,
wherein the circuitry is further configured to perform character recognition on document image data acquired from a client device, analyze both electronic information and the character information by natural language processing and text extraction on a sentence or item basis, and determine presence or absence of required items and consistency of values based on predetermined item definition data or template data stored in a storage device.

5. The system according to claim 4,
wherein the circuitry generates inconsistency data comprising presence or absence of inconsistencies, locations, types, and importance levels based on the natural language processing and natural language output from the generative neural network model, and transmits the inconsistency data and the explanation data as notification data to the terminal device.

6. The system according to claim 5,
wherein the circuitry is further configured to execute emotion estimation processing to estimate an emotional state of a user from at least one of voice data, image data, and character input data received from the terminal device, and change at least one of a presentation mode and a priority of the notification data in accordance with the estimated emotional state.

7. The system according to claim 6,
wherein changing the presentation mode comprises at least one of postponing non-critical notification items, modifying a detail level of the notification data, and reordering notification items to prioritize critical inconsistencies when the emotional state indicates elevated stress.

8. The system according to claim 1,
wherein the circuitry is further configured to generate structured comparison data by associating values derived from the physical medium and values derived from the electronic information for respective comparison items, input the structured comparison data into the determination model to output for each comparison item a consistency index and a content inconsistency result, and generate analysis result data comprising inconsistency items with associated values and consistency indices.

9. The system according to claim 8,
wherein the circuitry constructs the prompt data structure by embedding the analysis result data as structured fields and instructs the generative neural network model to generate a user-oriented natural language explanation of the content inconsistencies based on the embedded structured fields.

10. The system according to claim 9,
wherein the circuitry is further configured to analyze user input data by an emotion estimation program to determine an emotional state, and adjust at least one of a notification priority, a presentation format, and an expression content of notification regarding the content inconsistencies based on the emotional state.

11. The system according to claim 1,
wherein the circuitry is further configured to apply natural language processing and statistical string analysis to convert the character information into the structured data comprising multiple information items, perform item-level collation between information items obtained from electronic medium sources and information items obtained from physical medium sources to determine match data, mismatch data, and missing data.

12. The system according to claim 11,
wherein the circuitry computes importance evaluation data for the mismatch data and the missing data by using a machine learning model, and generates guidance data as a prompt data structure comprising at least the structured data and the mismatch data for input to the generative neural network model.

13. The system according to claim 12,
wherein the circuitry estimates an emotional state of a user by fusing results of voice data analysis, image data analysis, and textual emotion analysis applied to user signal data received from the terminal device, and generates notification control data for dynamically determining timing, medium, and expression style of notification data based on the emotional state and the importance evaluation data.

14. The system according to claim 13,
wherein the circuitry transmits the notification data comprising at least a portion of response data from the generative neural network model to the terminal device in accordance with the notification control data, and records the notification control data and user response data in the history data for subsequent refinement of the emotion estimation processing and notification parameters.

15. The system according to claim 1,
wherein the determination model comprises a classifier trained on labeled comparison-target pairs, each labeled pair comprising a pair of text segments with an associated ground-truth inconsistency label, and the reliability value comprises a confidence score output by the classifier.

16. The system according to claim 1,
wherein generating the display data comprises annotating a visual representation of the information group with markers at locations corresponding to detected inconsistencies, each marker linked to a corresponding portion of the explanation data.

17. The system according to claim 1,
wherein updating the determination model comprises incorporating the validity data as corrected labels for comparison-target pairs that were classified as determination-not-possible, and retraining the determination model using the corrected labels.

18. A system comprising:
circuitry configured to:
acquire an information group comprising electronic information and information derived from a physical medium, execute optical character recognition on at least a portion of the information group, and generate structured data by natural language processing and information extraction;
align information units across the electronic information and the information derived from the physical medium to generate comparison-target pairs;
input each comparison-target pair to a machine-learning-based determination model to generate determination data indicating presence or absence of a content inconsistency;
classify information units by inconsistency status and generate importance data and notification-priority data;
construct a prompt data structure comprising the structured data and the determination data, transmit the prompt data structure to a generative neural network model, and obtain explanation data;
generate display data for a terminal device based on the explanation data and the importance data; and
acquire evaluation data from the terminal device and store the evaluation data as history data for updating the determination model.

19. The system according to claim 18,
wherein the circuitry is further configured to estimate an emotional state of a user from at least one of voice data, image data, and character input data, and adjust notification priority or presentation mode based on the emotional state.

20. A method comprising:
acquiring, by circuitry via a communication interface coupled to a packet-switched network, an information group comprising electronic information and information derived from a physical medium, and executing optical character recognition on at least a portion of the information group to generate character information;
analyzing the character information by natural language processing and information extraction to generate structured data;
aligning information units across the electronic information and the information derived from the physical medium to generate comparison-target pairs, and inputting each comparison-target pair to a determination model to generate determination data indicating presence or absence of a content inconsistency;
classifying information units based on the determination data and generating importance data and notification-priority data;
constructing a prompt data structure comprising the structured data and the determination data, transmitting the prompt data structure to a generative neural network model, and obtaining explanation data; and
generating display data for a terminal device based on the explanation data and the importance data, and acquiring evaluation data for updating the determination model.
